(19) United States
(12) Patent Application Publication
(10) Pub. No.: US 2022/0299676 A1
(43) Pub. Date: Sep. 22, 2022

(54) METHODS AND SYSTEMS FOR WELL-TO-CELL COUPLING IN RESERVOIR SIMULATION

(71) Applicant: ROXAR SOFTWARE SOLUTIONS AS, Stavanger (NO)

(72) Inventor: Radek PECHER, Witney (GB)

(73) Assignee: ROXAR SOFTWARE SOLUTIONS AS, Stavanger (NO)

(21) Appl. No.: 17/639,518

(22) PCT Filed: Sep. 9, 2019
(86) PCT No.: PCT/EP2019/074009

§ 371 Date: Mar. 1, 2022

(51) Int. Cl. G01V 99/00; E21B 41/00

(52) U.S. Cl. CPC G01V 99/005; E21B 41/00

(57) ABSTRACT

A free-space well connection method of determining parameters for modeling a reservoir is disclosed. The method is conducted by a computer system (100) having a processor (110) and non-transitory memory (120) that stores data including instructions to be executed by the processor (110), the processor (110) executing a modeling module (102) stored in the memory (120), the modeling module (102) having data representing a grid with a well-cell (202) and at least one link-cell (204), each of the at least one link-cell (204ᵢ) having a common face (Γᵢ) with the well-cell (202), the well-cell (202) and the at least one link-cell (204) being a local cell array. The method comprises steps of modeling, by the modeling module (102), the local cell array as having an infinite outer boundary by modeling the grid as an infinite space around the local cell array for determination of parameters for the well-cell (202) and determining, by the modeling module (102), one or more of a well connection transmissibility factor (T_{w}) and at least one inter-cell transmissibility multiplier (Mᵢ).

### TECHNICAL FIELD

The embodiments described below relate to systems for determining flow characteristics, the embodiments further relate to reservoir modeling.

### BACKGROUND

In hydrocarbon reservoir simulation studies, mathematical coupling between the numerical grid cells, representing subterranean rock formations, and the well model is of crucial importance. Numerically, cells containing well perforations represent regions with the highest fluid velocities, and yet the present (new-generation) reservoir simulators still rely on outdated, oversimplified well-to-cell coupling models known as (“projected”) Peaceman formulae. The formulae also fail to adequately characterize partial well penetration, inclined well trajectory, off-center well location, multiple localized perforations and other topological deviations, as the Peaceman formulae assume idealistic cylindrical radial flow.

Reservoir simulation software mathematically describes the fluid flow through porous rock by means of nonlinear partial differential equations (hereinafter, “PDEs”), which are then solved numerically using the finite volume method (hereinafter, “FVM”) or other methods over a grid of millions/billions of cells intersected by hundreds/thousands of wells representing FVM sources or sinks. The mathematical coupling between the equations of fluid flow between cells and in wells has a strong impact on the computed well flowrates, and hence on the economic measures affecting companies' decisions. A modest improvement of the Peaceman formulae was introduced with Holmes's model in Schlumberger ECLIPSE, teaching “projected” approximation for non-vertical wells.
1. Peaceman, D. W. 1978. Interpretation of Well-Block Pressures in Numerical Reservoir Simulation. Paper SPE 6893 presented at the 1977 SPE AIME Annual Fall Technical Conference and Exhibition, Denver, 9-12 October. https://doi.org/10.2118/6893-PA
2. Peaceman, D. W. 1983. Interpretation of Well-Block Pressures in Numerical Reservoir Simulation with Nonsquare Grid Blocks and Anisotropic Permeability. Paper SPE 10528 presented at the 1982 SPE Symposium on Reservoir Simulation, New Orleans, 31 January-3 February. https://doi.org/10.2118/10528-PA
3. Schlumberger 2004. Schedule User Guide, Chap. 6. In ECLIPSE Reservoir Simulation Software 2004A manuals.

These publications are referred to by number in the specification as Ref. 1, Ref. 2, and Ref. 3, respectively.

Peaceman's formulae, including their generalized extensions, are all based on a key assumption of a cylindrical radial flow around the well, which becomes invalid when the well to cell relative geometry deviates from the ideal, fully symmetric case, or when the rock properties vary spatially, as in heterogenous media, which is almost always the case. There have been numerous attempts from various researchers to improve this deficiency, but none have been adequate.

Publications regarding multi-point well connections utilized by reference in this specification may include elements of the following publications:
4. Pecher, R., 2014. Methods and Systems for Simulating a Hydrocarbon Field Using a Multi-Point Well Connection Method. U.S. Patent Application No. PCT/US2015/043223 (USPTO, October 2015). https://patents.google.com/patent/US20170212773
5. Pecher, R., 2014. Modeling Fluid-Conducting Fractures in Reservoir Simulation Grids. U.S. patent application Ser. No. 14/644,306 (USPTO, May 2015). https://patents.google.com/patent/US20160131800
6. Pecher, R., 2015. Breaking the Symmetry with the Multi-Point Well Connection Method. Paper SPE 173302 presented at SPE Reservoir Simulation Symposium, Houston, Tex., USA (February 23-25). https://doi.org/10.2118/173302-MS

These publications are referred to by number in the specification as Ref. 4, Ref. 5, and Ref. 6, respectively. Refs. 4-6 may be used to determine outer boundary conditions for a local boundary value problem (hereinafter, “LBVP”) by using true dynamic simulation values. Alternatively, arbitrarily chosen values may be used. Other methods involve outer boundary conditions assigned to fictitious boundaries around the domain of interest. These are:
7. Wolfsteiner, C., Durlofsky, L. J., and Aziz, K. 2003. Calculation of Well Index for Nonconventional Wells on Arbitrary Grids. Computat Geosci 7 (1): 61-82. http://dx.doi.org/10.1023/A:1022431729275
8. Schlumberger 2019. Technical Description. In INTERSECT Reservoir Simulation Software 2019.1 manuals.
9. Novikov, A. V., Posvyanskii, V. S., and Posvyanskii, D. V. 2017. An application of Green's function technique for computing well inflow without radial flow assumption. Computat Geosci 21 (5-6): 1049-1058. http://dx.doi.org/10.1007/s10596-017-9684-6

These publications may be referred to by number in the specification as Ref. 7, Ref 8, and Ref. 9, respectively.

The references, Refs. 1-9, are recognized in the art and are merely presented to demonstrate enablement by virtue of the state of the art and the knowledge possessed by a person skilled in the art. All methods, procedures, and implementations of these publications are contemplated by the specification. If elements of the references and the specification appear incongruent or appear to contradict one another, this specification contemplates the elements as disclosed in this specification.

The multi-point well connection method (hereinafter, “MPWC”) in existence requires significant implementation effort and computational power. Traditional MPWC methods use neighboring cell values as boundary conditions necessary to determine the properties of each cell. Cell pressures are determined at simulation time, requiring increased computational power.

Accordingly, there is a need for improving the methods and equipment for determining reservoir, wellbore, and/or well-to-cell coupling properties.

### SUMMARY

A free-space well connection method of determining parameters for modeling a reservoir is disclosed. The method is conducted by a computer system (100) having a processor (110) and non-transitory memory (120) that stores data including instructions to be executed by the processor (110), the processor (110) executing a modeling module (102) stored in the memory (120), the modeling module (102) having data representing a grid with a well-cell (202) and at least one link-cell (204), each of the at least one link-cell (204ᵢ) having a common face (Γᵢ) with the well-cell (202), the well-cell (202) and the at least one link-cell (204) being a local cell array. The method comprises steps of modeling, by the modeling module (102), the local cell array as having an infinite outer boundary by modeling the grid as an infinite space around the local cell array for determination of parameters for the well-cell (202) and determining, by the modeling module (102), one or more of a well connection transmissibility factor (T_{w}) and at least one inter-cell transmissibility multiplier (Mᵢ).

A computer system (100) having a processor (110) and non-transitory memory (120) that stores data including instructions to be executed by the processor (110), the processor (110) configured to carry out a free-space well connection method of determining parameters for modeling a reservoir by executing a modeling module (102) stored in the memory (120), the modeling module (102) having data representing a grid with a well-cell (202) and at least one link-cell (204), each of the at least one link-cell (204ᵢ) having a common face (Γᵢ) with the well-cell (202), the well-cell (202) and the at least one link-cell (204) being a local cell array is disclosed. The modeling module (102) is configured to model the local cell array as having an infinite outer boundary by modeling the grid as an infinite space around the local cell array for determination of parameters for the well-cell (202) and to determine one or more of a well connection transmissibility factor (T_{w}) and at least one inter-cell transmissibility multiplier (Mᵢ).

### Aspects

According to an aspect, a free-space well connection method of determining parameters for modeling a reservoir is disclosed. The method is conducted by a computer system (100) having a processor (110) and non-transitory memory (120) that stores data including instructions to be executed by the processor (110), the processor (110) executing a modeling module (102) stored in the memory (120), the modeling module (102) having data representing a grid with a well-cell (202) and at least one link-cell (204), each of the at least one link-cell (204ᵢ) having a common face (Γᵢ) with the well-cell (202), the well-cell (202) and the at least one link-cell (204) being a local cell array. The method comprises steps of modeling, by the modeling module (102), the local cell array as having an infinite outer boundary by modeling the grid as an infinite space around the local cell array for determination of parameters for the well-cell (202) and determining, by the modeling module (102), one or more of a well connection transmissibility factor (T_{w}) and at least one inter-cell transmissibility multiplier (Mᵢ).

Preferably, the method further comprises modeling, by the modeling module (102), the at least one link-cell (204), as having infinitesimal thickness, by assuming the flow through the common face is the same as the flow out of the link-cell (204) through an external face of the link-cell (204) and a pressure difference between inner and outer faces of the common face (Γᵢ) is proportional to a volumetric fluid flowrate between the well-cell (202) and one of the at least one link-cells (204ᵢ) across a thin layer of equivalent transmissibility (T_{0i,i}).

Preferably, the method further comprises determining, by the modeling module (102), a minimum distance between a well perforation (Γ_{w}) in the well-cell (202) and a point on the common face (Γᵢ) and splitting, by the modeling module (102), the common face (Γᵢ) into more than one boundary element of a plurality of boundary elements if the minimum distance between a well perforation (Γ_{w}) in the well-cell (202) and a point on the common face (Γᵢ), is less than a predetermined threshold.

Preferably, the point on the common face (Γᵢ) is the point closest to the well perforation (Γ_{w}).

Preferably, the point on the common face (Γᵢ) is the center point of the common face (Γᵢ).

Preferably, if the minimum distance between a well perforation (Γ_{w}) in the well-cell (202) and a point on the common face (Γᵢ), is not less than a predetermined threshold, the common face (Γᵢ) is considered a boundary element of the plurality of boundary elements.

Preferably, the method further comprises determining, by the modeling module (102), a minimum distance between a well perforation (Γ_{w}) in the well-cell (202) and a point on a boundary element of the plurality of boundary elements and splitting, by the modeling module (102), the boundary element of the plurality of boundary elements into more than one boundary element of the plurality of boundary elements if the minimum distance (d_{iw}) between a well perforation (Γ_{w}) in the well-cell (202) and a point on the boundary element of the plurality of boundary elements is less than a predetermined threshold.

Preferably, the determination of whether the minimum distance (d_{iw}) is less than a predetermined threshold comprises determining whether one of the ratio of the square of the minimum distance (d_{iw}) to an area of the common face (Γᵢ) and the ratio of the minimum distance (d_{iw}) to a square root of the area of the common face (Γᵢ) is less than a predetermined ratio threshold.

Preferably, the more than one boundary element is four boundary elements.

Preferably, the more than one boundary element is nine boundary elements.

Preferably, the method further comprises determining, by the modeling module (102), a bounding box for one or more of a well perforation (Γ_{w}) and a well perforation segment and splitting, by the modeling module (102), the one or more of the well perforation (Γ_{w}) and a well perforation segment into more than one segment if the bounding box size is above a predetermined threshold.

Preferably, the determination of whether the bounding box size is above a predetermined threshold comprises determining whether the maximum dimension (max(b_{w}/b_{c})) of a ratio of well perforation (segment) bounding box (b_{w}) to a well-cell (202) bounding box (b_{c}) exceeds a predetermined ratio threshold.

Preferably, the more than one segment is two segments.

Preferably, the more than one segment is four segments.

Preferably, the cell array is analyzed, by the modeling module (102), by dividing the interface between the well-cell (202) and a link-cell (204) of each of the at least one link-cell (204) and an external environment into “layers”, with an “inner layer” representing a relationship of flow between a well perforation (Γ_{w}) and the common face (Γ₀ᵢ≡∂Ω₀∩∂Ωᵢ), a “link layer” representing a relationship of flow between the common face (Γ₀ᵢ) and the outer link-cell (204i) face (Γ_{i∞}≡∂Ωᵢ∩∂Ω_{∞}), and an “outer layer” representing the relationship of flow between the outer link-cell (204i) face (Γ_{i∞}) and the remote boundary (Γ_{∞}) of an infinite domain (Ω_{∞}).

Preferably, the determining, by the modeling module (102), one or more of a well connection transmissibility factor (T_{w}) and at least one inter-cell transmissibility multiplier (Mᵢ) comprises evaluating, by the modeling module (102), inner layer equations to form at least one inner boundary condition relation representing physical relationships in the inner layer.

Preferably, one of the inner layer equations evaluated, by the modeling module (102), to form one of the at least one inner boundary condition relation is ∫_{Λ}_{_{w}}I_{w}dλ+Σᵢ₌₁ⁿ∫_{Λ}_{_{w}}Iᵢdλ=0, wherein Λ_{w} is the well perforation segments in the well-cell, I_{w} is an integral ∫_{Γ}_{_{w}}(P_{w}F−c_{w}Q_{w}G)dγ, Iᵢ is an integral ∫_{Γ}_{ᵢ}(P₀ᵢF−cᵢQᵢfG)dγ, and n is a number of boundary elements, wherein P_{w} is the wellbore pressure, G is a free-space Green's function, F is a normal component of the gradient/flux of G, Γ_{w} is well perforations, P₀ᵢ is pressure on the common face (Γ₀ᵢ), c_{w} is a coefficient relating flux on well perforations (Γ_{w}), cᵢ is a coefficient relating flux on the common face (Γ₀ᵢ), Qᵢ is the volumetric fluid flowrate between well-cell (202) and the link-cell (204ᵢ), and Q_{w} is the total volumetric fluid flowrate through a well.

Preferably, a number of the inner layer equations with integrals evaluated to form a number of inner boundary condition relations of the at least one inner boundary condition relation is ∫_{Γ}_{ᵢ}I_{w}dγ+Σⱼ₌₁ⁿ∫_{Γ}_{ᵢ}Iⱼdγ=½P₀ᵢ, wherein n is a total number of boundary elements.

Preferably, the integrals in inner layer equations ∫_{Γ}_{ᵢ}I_{w}dγ+Σⱼ₌₁ⁿ∫_{Γ}_{ᵢ}Iⱼdγ=½P₀ᵢ are evaluated numerically.

Preferably, a total number of the at least one inner boundary condition relation for the local cell array is one plus the total number of boundary elements.

Preferably, the determining, by the modeling module (102), one or more of a well connection transmissibility factor (T_{w}) and at least one inter-cell transmissibility multiplier (Mᵢ) comprises determining, by the modeling module (102), link equations to form at least one link boundary condition relation between the inner side and outer side of a boundary element.

Preferably, a number of the link equations determined to form a number of link boundary condition relations of the at least one link boundary condition relation are Qᵢ=T_{0i,i}(P₀ᵢ−Pᵢ), wherein both the number of the link equations and the number of link boundary condition relations is the total number of boundary elements.

Preferably, the method further comprises determining, by the modeling module (102), whether the each of the link-cells (204ᵢ) is of a set of active link-cells ( [symbol] ) or of a set of inactive link-cells ( [symbol] ), if a link-cell (204i) is of the set of active link-cells ( [symbol] ), then apply, by the modeling module (102), a Robin type boundary condition relation as at least one link boundary condition relation of the link-cell (204ᵢ), and if a link-cell (204i) is of the set of inactive link-cells ( [symbol] ), then apply, by the modeling module (102), a Neumann type boundary condition relation as at least one link boundary condition relation of the link-cell (204ᵢ).

Preferably, the determining, by the modeling module (102), one or more of a well connection transmissibility factor (T_{w}) and at least one inter-cell transmissibility multiplier (Mᵢ) comprises determining, by the modeling module (102), outer layer equations to form at least one outer boundary condition relation representing physical relationships in the outer layer.

Preferably, a number of the outer layer equations determined to form a number of outer boundary condition relations of the at least one outer boundary condition relation are Σⱼ₌₁ⁿ∫_{Γ}_{ᵢ}Iⱼdγ=½Pᵢ, wherein both the number of the outer layer equations and the number of outer boundary condition relations are the total number of boundary elements.

Preferably, the determining, by the modeling module (102), one or more of a well connection transmissibility factor (T_{w}) and at least one inter-cell transmissibility multiplier (Mᵢ), uses a total number of boundary condition relations, the total number of boundary condition relations being three times the number of boundary elements of the local cell array plus one (3n+1).

Preferably, the determining, by the modeling module (102), one or more of a well connection transmissibility factor (T_{w}) and at least one inter-cell transmissibility multiplier (Mᵢ), comprises assembling all boundary condition relations in a matrix and a right-hand side vector of equation coefficients.

Preferably, the determining, by the modeling module (102), one or more of a well connection transmissibility factor (T_{w}) and at least one inter-cell transmissibility multiplier (Mᵢ), comprises determining one or more of a total volumetric flowrate in the well (Q_{w}), a pressure on the well-cell side of each common face (P₀ᵢ), a volumetric fluid flowrate between well-cell and each link-cell (Qᵢ) and a pressure in each link-cell (Pᵢ), by resolving, using the modeling module (102), a system of equations represented by the matrix and the right-hand side vector of equation coefficients.

Preferably, the determining, by the modeling module (102), one or more of a well connection transmissibility factor (T_{w}) and at least one inter-cell transmissibility multiplier (Mᵢ), comprises determining the well-cell pressure (P₀) from the determined total volumetric flowrate in the well (Q_{w}), a pressure on the well-cell side of each common face (P₀ᵢ), a volumetric fluid flowrate between well-cell and each link-cell (Qᵢ) and a pressure in each link-cell (Pᵢ).

Preferably, the determining of the well-cell pressure (P₀) from the determined one or more of a total volumetric flowrate in the well (Q_{w}), a pressure on the well-cell side of each common face (P₀ᵢ), a volumetric fluid flowrate between well-cell and each link-cell (Qᵢ) and a pressure in each link-cell (Pᵢ) comprises finding a root of

$${\sum }_{i ∈ 𝔸} \frac{{Q}_{i}}{{T}_{i} ( {P}_{0} - {P}_{i} )} = {N}_{𝔸}$$

with respect to well-cell pressure (P₀).

Preferably, the determining, by the modeling module (102), one or more of a well connection transmissibility factor (T_{w}) and at least one inter-cell transmissibility multiplier (Mᵢ), further comprises determining the one or more of a well connection transmissibility factor (T_{w}) and at least one inter-cell transmissibility multiplier (Mᵢ) from the well-cell pressure (P₀), the pressure in each link-cell (Pᵢ) and a wellbore pressure (P_{w}).

Preferably, the determining the one or more of a well connection transmissibility factor (T_{w}) and at least one inter-cell transmissibility multiplier (Mᵢ) from the well-cell pressure (P₀) is conducted, by the modeling module (102), using equations Qᵢ=MᵢTᵢ(P₀−Pᵢ) and (Q_{w}=T_{w}(P₀−P_{w}).

Preferably, the well-cell (202) shares a common cell-face with another well-cell, wherein the inter-cell transmissibility multiplier of the common cell-face is resolved, using the modeling module (102), by averaging values of inter-cell transmissibility multipliers (Mᵢ) determined for each of the well-cell (202) and the another well-cell.

Preferably, a sum of values of the at least one inter-cell transmissibility multiplier (ΣᵢMᵢ) is equal to a total number of link-cells (204) in a set of active link-cells ( [symbol] ) in the local cell array.

Preferably, the method further comprises transmitting the one or more of a well connection transmissibility factor (T_{w}) and at least one inter-cell transmissibility multiplier (Mᵢ) to a reservoir simulation that simulates fluid flow in a reservoir and using, by the reservoir simulator, the one or more of a well connection transmissibility factor (T_{w}) and at least one inter-cell transmissibility multiplier (Mᵢ) to simulate fluid flow in a reservoir.

Preferably, the reservoir simulation does not adjust the values of the one or more of a well connection transmissibility factor (T_{w}) and at least one inter-cell transmissibility multiplier (Mᵢ) during the simulation, by the reservoir simulator, of fluid flow in a reservoir.

Preferably, the determining, by the modeling module (102), one or more of a well connection transmissibility factor (T_{w}) and at least one inter-cell transmissibility multiplier (Mᵢ), accounts for a shape function (ƒ(x, x′)), the shape function representing variations in flux over the common face (Γᵢ).

Preferably, the method further comprises receiving, determining, or inputting, by the modeling module (102), inputs for determining at least one inter-cell transmissibility multiplier and at least one well connection transmissibility factor and determining, by the modeling module (102), whether the well-cell (202) is active, based on the inputs.

Preferably, the method further comprises stopping a FSWC evaluation of the local cell array if the modeling module (102) determines the well-cell (202) is not active.

Preferably, the method further comprises, if a hydraulic conductivity (K) is a non-diagonal tensor within a predetermined threshold, applying mapping, by the modeling module (102), to spatial coordinates, making the hydraulic conductivity (K) a diagonal tensor.

Preferably, the method further comprises, if a hydraulic conductivity (K) is not a scalar within a predetermined threshold, applying mapping, by the modeling module (102) to spatial coordinates, making the hydraulic conductivity (K) a scalar.

Preferably, the method further comprises determining, by the modeling module (102), the hydraulic conductivity (K) is a scalar if the hydraulic conductivity (K) is within a predetermined threshold for determining that a hydraulic conductivity (K) is a scalar.

Preferably, the method further comprises determining, by the modeling module (102), the hydraulic conductivity (K) is a diagonal tensor if the hydraulic conductivity (K) is within a predetermined threshold for determining that a hydraulic conductivity (K) is a diagonal tensor.

Preferably, identifying of inactive cells is based on a determination, by the modeling module (102), that the cell has one or more of a pore volume that is below a predetermined pore volume threshold, a permeability below a predetermined permeability threshold, and a transmissibility below a predetermined transmissibility threshold.

Preferably, the method further comprises initializing global parameters for the FSWC based model.

Preferably, the determining, by the modeling module (102), one or more of a well connection transmissibility factor (T_{w}) and at least one inter-cell transmissibility multiplier (Mᵢ), accounts, by the modeling module (102) for a skin factor (S) which is incorporated by the equation, r̅_{w}=r_{w}e^{-S}.

According to an aspect, a computer system (100) having a processor (110) and non-transitory memory (120) that stores data including instructions to be executed by the processor (110), the processor (110) configured to carry out a free-space well connection method of determining parameters for modeling a reservoir by executing a modeling module (102) stored in the memory (120), the modeling module (102) having data representing a grid with a well-cell (202) and at least one link-cell (204), each of the at least one link-cell (204) having a common face (Γᵢ) with the well-cell (202), the well-cell (202) and the at least one link-cell (204) being a local cell array is disclosed. The modeling module (102) is configured to model the local cell array as having an infinite outer boundary by modeling the grid as an infinite space around the local cell array for determination of parameters for the well-cell (202) and to determine one or more of a well connection transmissibility factor (T_{w}) and at least one inter-cell transmissibility multiplier (Mᵢ).

Preferably, the modeling module (102) is further configured to model the at least one link-cell (204), as having infinitesimal thickness, by assuming the flow through the common face is the same as the flow out of the link-cell (204) through an external face of the link-cell (204), and a pressure difference between inner and outer faces of the common face (Γᵢ) is proportional to a volumetric fluid flowrate between the well-cell (202) and one of the at least one link-cells (204ᵢ) across a thin layer of equivalent transmissibility (T_{0i,i}).

Preferably, the modeling module (102) is further configured to determine, by the modeling module (102), a minimum distance between a well perforation (Γ_{w}) in the well-cell (202) and a point on the common face (Γᵢ) and split, by the modeling module (102), the common face (Γᵢ) into more than one boundary element of a plurality of boundary elements if the minimum distance between a well perforation (Γ_{w}) in the well-cell (202) and a point on the common face (Γᵢ), is less than a predetermined threshold.

Preferably, the point on the common face (Γᵢ) is the point closest to the well perforation (Γ_{w}).

Preferably, the point on the common face (Γᵢ) is the center point of the common face (Γᵢ).

Preferably, if the minimum distance between a well perforation (Γ_{w}) in the well-cell (202) and a point on the common face (Γᵢ), is not less than a predetermined threshold, the common face (Γᵢ) is considered a boundary element of the plurality of boundary elements.

Preferably, the modeling module (102) is further configured to determine a minimum distance between a well perforation (Γ_{w}) in the well-cell (202) and a point on a boundary element of the plurality of boundary elements and split the boundary element of the plurality of boundary elements into more than one boundary element of the plurality of boundary elements if the minimum distance (d_{iw}) between a well perforation (Γ_{w}) in the well-cell (202) and a point on the boundary element of the plurality of boundary elements is less than a predetermined threshold.

Preferably, the determination of whether the minimum distance (d_{iw}) is less than a predetermined threshold comprises determining, by the modeling module (102) whether one of the ratio of the square of the minimum distance (d_{iw}) to an area of the common face (Γᵢ) and the ratio of the minimum distance (d_{iw}) to a square root of the area of the common face (Γᵢ) is less than a predetermined ratio threshold.

Preferably, the more than one boundary element is four boundary elements.

Preferably, the more than one boundary element is nine boundary elements.

Preferably, the modeling module (102) is further configured to determine a bounding box for one or more of a well perforation (Γ_{w}) and a well perforation segment and split the one or more of the well perforation (Γ_{w}) and a well perforation segment into more than one segment if the bounding box size is above a predetermined threshold.

Preferably, the determination of whether the bounding box size is above a predetermined threshold comprises determining, by the modeling module (102) whether the maximum dimension (max(b_{w}/b_{c})) of a ratio of well perforation (segment) bounding box (b_{w}) to a well-cell (202) bounding box (b_{c}) exceeds a predetermined ratio threshold.

Preferably, the more than one segment is two segments.

Preferably, the more than one segment is four segments.

Preferably, the cell array is analyzed, by the modeling module (102), by dividing the interface between the well-cell (202) and a link-cell (204ᵢ) of each of the at least one link-cell (204) and an external environment into “layers”, with an “inner layer” representing a relationship of flow between a well perforation (Γ_{w}) and the common face (Γ₀ᵢ≡∂Ω₀∩∂Ωᵢ), a “link layer” representing a relationship of flow between the common face (Γ₀ᵢ) and the outer link-cell (204i) face (Γ_{i∞}≡∂Ωᵢ∩∂Ω_{∞}), and an “outer layer” representing the relationship of flow between the outer link-cell (204i) face (Γ_{i∞}) and the remote boundary (Γ_{∞}) of an infinite domain (Ω_{∞}).

Preferably, the determining, by the modeling module (102), one or more of a well connection transmissibility factor (T_{w}) and at least one inter-cell transmissibility multiplier (Mᵢ), comprises evaluating, by the modeling module (102), inner layer equations to form at least one inner boundary condition relation representing physical relationships in the inner layer.

Preferably, one of the inner layer equations evaluated, by the modeling module (102), to form one of the at least one inner boundary condition relation is ∫_{Λ}_{_{w}}I_{w}dλ+Σᵢ₌₁ⁿ∫_{Λ}_{_{w}}Iᵢdλ=0, wherein Λ_{w} is the well perforation segments in the well-cell, I_{w} is an integral ∫_{Γ}_{_{w}}(P_{w}F−c_{w}Q_{w}G)dγ, Iᵢ is an integral ∫_{Γ}_{ᵢ}(P₀ᵢF−cᵢQᵢfG)dγ, and n is a number of boundary elements, wherein P_{w} is the wellbore pressure, G is a free-space Green's function, F is a normal component of the gradient/flux of G, Γ_{w} is well perforations, P₀ᵢ is pressure on the common face (Γ₀ᵢ), c_{w} is a coefficient relating flux on well perforations (Γ_{w}), cᵢ is a coefficient relating flux on the common face (Γ₀ᵢ), Qᵢ is the volumetric fluid flowrate between well-cell (202) and the link-cell (204ᵢ), and Q_{w} is the total volumetric fluid flowrate in the well.

Preferably, a number of the inner layer equations with integrals evaluated to form a number of inner boundary condition relations of the at least one inner boundary condition relation is ∫_{Γ}_{ᵢ}I_{w}dγ+Σⱼ₌₁ⁿ∫_{Γ}_{ᵢ}Iⱼdγ=½P₀ᵢ, wherein n is a total number of boundary elements.

Preferably, the integrals in inner layer equations ∫_{Γ}_{ᵢ}I_{w}dγ+Σⱼ₌₁ⁿ∫_{Γ}_{ᵢ}Iⱼdγ=½P₀ᵢ are evaluated numerically.

Preferably, a total number of the at least one inner boundary condition relation for the local cell array is one plus the total number of boundary elements.

Preferably, the determining, by the modeling module (102), one or more of a well connection transmissibility factor (T_{w}) and at least one inter-cell transmissibility multiplier (Mᵢ), comprises determining, by the modeling module (102), link equations to form at least one link boundary condition relation between the inner side and outer side of a boundary element.

Preferably, a number of the link equations determined to form a number of link boundary condition relations of the at least one link boundary condition relation are Qᵢ=T_{0i,i}(P₀ᵢ−Pᵢ), wherein both the number of the link equations and the number of link boundary condition relations is the total number of boundary elements.

Preferably, the modeling module (102) is further configured to determine whether the each of the link-cells (204ᵢ) is of a set of active link-cells ( [symbol] ) or of a set of inactive link-cells ( [symbol] ), if a link-cell (204i) is of the set of active link-cells ( [symbol] ), then apply, by the modeling module (102), a Robin type boundary condition relation as at least one link boundary condition relation of the link-cell (204ᵢ), and if a link-cell (204i) is of the set of inactive link-cells ( [symbol] ), then apply, by the modeling module (102), a Neumann type boundary condition relation as at least one link boundary condition relation of the link-cell (204ᵢ).

Preferably, the determining, by the modeling module (102), one or more of a well connection transmissibility factor (T_{w}) and at least one inter-cell transmissibility multiplier (Mᵢ), comprises determining, by the modeling module (102), outer layer equations to form at least one outer boundary condition relation representing physical relationships in the outer layer.

Preferably, a number of the outer layer equations determined to form a number of outer boundary condition relations of the at least one outer boundary condition relation are Σⱼ₌₁ⁿ∫_{Γ}_{ᵢ}Iⱼdγ=½Pᵢ, wherein both the number of the outer layer equations and the number of outer boundary condition relations are the total number of boundary elements.

Preferably, the determining, by the modeling module (102), one or more of a well connection transmissibility factor (T_{w}) and at least one inter-cell transmissibility multiplier (Mᵢ), uses a total number of boundary condition relations, the total number of boundary condition relations being three times the number of boundary elements of the local cell array plus one (3n+1).

Preferably, the determining, by the modeling module (102), one or more of a well connection transmissibility factor (T_{w}) and at least one inter-cell transmissibility multiplier (Mᵢ), comprises assembling, by the modeling module (102) all boundary condition relations in a matrix and a right-hand side vector of equation coefficients.

Preferably, the determining, by the modeling module (102), one or more of a well connection transmissibility factor (T_{w}) and at least one inter-cell transmissibility multiplier (Mᵢ), comprises determining one or more of a total volumetric flowrate in the well (Q_{w}), a pressure on the well-cell side of each common face (P₀ᵢ), a volumetric fluid flowrate between well-cell and each link-cell (Qᵢ) and a pressure in each link-cell (Pᵢ), by resolving, using the modeling module (102), a system of equations represented by the matrix and the right-hand side vector of equation coefficients.

Preferably, the determining, by the modeling module (102), one or more of a well connection transmissibility factor (T_{w}) and at least one inter-cell transmissibility multiplier (Mᵢ), comprises determining the well-cell pressure (P₀) from the determined total volumetric flowrate in the well (Q_{w}), a pressure on the well-cell side of each common face (P₀ᵢ), a volumetric fluid flowrate between well-cell and each link-cell (Qᵢ) and a pressure in each link-cell (Pᵢ).

Preferably, the determining of the well-cell pressure (P₀) from the determined one or more of a total volumetric flowrate in the well (Q_{w}), a pressure on the well-cell side of each common face (P₀ᵢ), a volumetric fluid flowrate between well-cell and each link-cell (Qᵢ) and a pressure in each link-cell (Pᵢ) comprises finding a root, by the modeling module (102), of

$${\sum }_{i ∈ 𝔸} \frac{{Q}_{i}}{{T}_{i} ( {P}_{0} - {P}_{i} )} = {N}_{𝔸}$$

with respect to well-cell pressure (P₀).

Preferably, the determining, by the modeling module (102), one or more of a well connection transmissibility factor (T_{w}) and at least one inter-cell transmissibility multiplier (Mᵢ), further comprises determining, by the modeling module (102), the one or more of a well connection transmissibility factor (T_{w}) and at least one inter-cell transmissibility multiplier (Mᵢ) from the well-cell pressure (P₀), the pressure in each link-cell (Pᵢ) and a wellbore pressure (P_{w}).

Preferably, the determining the one or more of a well connection transmissibility factor (T_{w}) and at least one inter-cell transmissibility multiplier (Mᵢ) from the well-cell pressure (P₀) is conducted, by the modeling module (102), using equations Qᵢ=MᵢTᵢ(P₀−Pᵢ) and Q_{w}=T_{w}(P₀−P_{w}).

Preferably, the well-cell (202) shares a common cell-face with another well-cell, wherein the inter-cell transmissibility multiplier of the common cell-face is resolved, using the modeling module (102), by averaging values of inter-cell transmissibility multipliers (Mᵢ) determined for each of the well-cell (202) and the another well-cell.

Preferably, a sum of values of the at least one inter-cell transmissibility multiplier (ΣᵢMᵢ) is equal to a total number of link-cells (204) in a set of active link-cells ( [symbol] ) in the local cell array.

Preferably, the modeling module (102) is further configured to transmit the one or more of a well connection transmissibility factor (T_{w}) and at least one inter-cell transmissibility multiplier (Mᵢ) to a reservoir simulation that simulates fluid flow in a reservoir and using, by the reservoir simulator, the one or more of a well connection transmissibility factor (T_{w}) and at least one inter-cell transmissibility multiplier (Mᵢ) to simulate fluid flow in a reservoir.

Preferably, the reservoir simulation does not adjust the values of the one or more of a well connection transmissibility factor (T_{w}) and at least one inter-cell transmissibility multiplier (Mᵢ) during the simulation, by the reservoir simulator, of fluid flow in a reservoir.

Preferably, the determining, by the modeling module (102), one or more of a well connection transmissibility factor (T_{w}) and at least one inter-cell transmissibility multiplier (Mᵢ), accounts for a shape function (ƒ(x, x′)), the shape function representing variations in flux over the common face (Γᵢ).

Preferably, the modeling module (102) is further configured to receive, determine, or input inputs for determining at least one inter-cell transmissibility multiplier and at least one well connection transmissibility factor and determine whether the well-cell (202) is active, based on the inputs.

Preferably, the modeling module (102) is further configured to stop a FSWC evaluation of the local cell array if the modeling module (102) determines the well-cell (202) is not active.

Preferably, if a hydraulic conductivity (K) is a non-diagonal tensor within a predetermined threshold, the modeling module (102) is configured to apply mapping to spatial coordinates, making the hydraulic conductivity (K) a diagonal tensor.

Preferably, if a hydraulic conductivity (K) is not a scalar within a predetermined threshold, the modeling module (102) is configured to apply mapping to spatial coordinates, making the hydraulic conductivity (K) a scalar.

Preferably, the modeling module (102) is further configured to determine the hydraulic conductivity (K) is a scalar if the hydraulic conductivity (K) is within a predetermined threshold for determining that a hydraulic conductivity (K) is a scalar.

Preferably, the modeling module is further configured to determine the hydraulic conductivity (K) is a diagonal tensor if the hydraulic conductivity (K) is within a predetermined threshold for determining that a hydraulic conductivity (K) is a diagonal tensor.

Preferably, identifying of inactive cells is based on a determination, by the modeling module (102), that the cell has one or more of a pore volume that is below a predetermined pore volume threshold, a permeability below a predetermined permeability threshold, and a transmissibility below a predetermined transmissibility threshold.

Preferably, the modeling module (102) is further configured to initialize global parameters for the FSWC based model.

Preferably, the determining, by the modeling module (102), one or more of a well connection transmissibility factor (T_{w}) and at least one inter-cell transmissibility multiplier (Mᵢ), accounts, by the modeling module (102) for a skin factor (S) which is incorporated by the equation, r̅_{w}=r_{w}e^{-S}.

### BRIEF DESCRIPTION OF THE DRAWINGS

The same reference number represents the same element on all drawings. It should be understood that the drawings are not necessarily to scale.

FIG. 1 shows a block diagram of an embodiment of a computer system 100 having a processor and memory for determining fluid characteristics.

FIG. 2 shows a rendition of an embodiment of a system portion 200 of an FVM grid with a well-cell 202 surrounded by link-cells 204.

FIG. 3 shows a block diagram of an embodiment of a comparison of how an original FVM model appears relative to a corresponding LBVP model.

FIG. 4 shows a perspective view 400 of an embodiment of a well-cell 202 in which well-cell faces are split into more boundary elements.

FIG. 5 shows perspective views of embodiments of different cell geometries.

FIG. 6 shows a graph 600 of an embodiment of a comparison of Eq. (33) against P₀ for the well-cell 202 shown in FIG. 4.

FIG. 7 shows a detailed rendition 700 of an embodiment of a system portion 200 of an FVM grid with a well-cell 202 surrounded by link-cells 204 of FIG. 2.

FIG. 8 shows a flowchart of an embodiment of a method 800 for generating an FSWC model.

FIG. 9 shows a flowchart of an embodiment of a method 900 for conducting a procedural setup procedure.

FIG. 10 shows a flowchart of an embodiment of a method 1000 for conducting a FSWC cell geometry setup procedure.

FIG. 11 shows a flowchart of an embodiment of a method 1100 for conducting a FSWC system of equations generating procedure.

FIG. 12 shows a flowchart of an embodiment of a method 1200 for conducting a FSWC system of equations evaluating procedure.

FIG. 13 shows a flowchart of an embodiment of a method 1300 for simplifying a FSWC system.

FIG. 14 shows a flowchart of another embodiment of a method 1400 for simplifying a FSWC system.

FIG. 15 shows a graph 1500 of an embodiment of a comparison of flow rates between the FSWC model and existing fine and coarse models.

FIG. 16 shows a graph 1600 of an embodiment of a comparison of pressures at different locations of a cell between the FSWC model and existing fine and coarse models.

### DETAILED DESCRIPTION

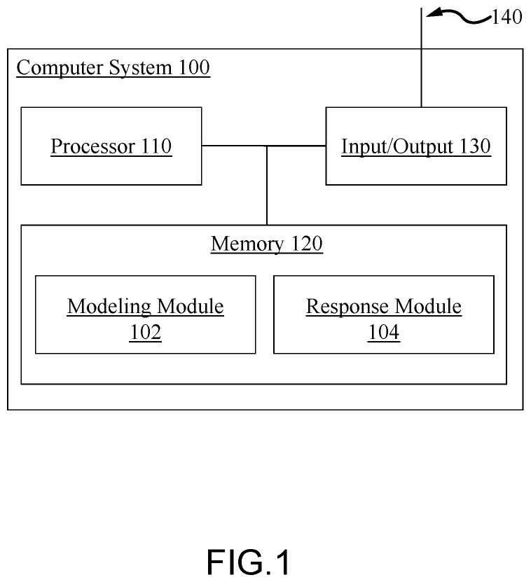

FIGS. 1-11 and the following description depict specific examples to teach those skilled in the art how to make and use the best mode of embodiments of methods and systems for reservoir modeling. For the purpose of teaching inventive principles, some conventional aspects have been simplified or omitted. Those skilled in the art will appreciate variations from these examples that fall within the scope of the present description. Those skilled in the art will appreciate that the features described below can be combined in various ways to form multiple variations of determining the flow characteristics. As a result, the embodiments described below are not limited to the specific examples described below, but only by the claims and their equivalents.

The specification may disclose embodiments that depart from traditional MPWC models. The embodiments may use what is called a free-space well connection (hereinafter, “FSWC”). The FSWC departs from MPWC in many ways, but an emphasized difference may be that the FSWC's well-to-cell coupling formula contains only a single cell pressure (namely the well-cell pressure) to be evaluated, whereas the MPWC formula contains at least two cell pressures (namely the well-cell pressure and at least one link-cell pressure). The FSWC may represent a significant computational saving relative to the existing MPWC method. The free-space well connection method may account for asymmetries in one or more of transmissibilities between the well-cell (202) and the at least one link-cell (204), locations within the well-cell of the perforation(s), spatial distribution of well perforations within the well-cell, geometry of the well-cell, and the trajectory of the well in space. The reservoir model produced by the FSWC may yield well flow parameter models that are continuous in space, which represents a significant improvement over spatially discontinuous parameter models computed by existing well-to-cell coupling methods. In reservoir applications, when gradually moving a well (in space) from one cell to another in a simulation grid and then comparing all the simulation results, the determined well flow rate can be a continuous function of space.

Unlike the two-point coupling formulae, such as Peaceman's, the multi-point coupling MPWC may require drastic changes in the computer source code. Every code-line with two pressure variables must be extended to eight or more pressure variables; this affects, for instance, property calculation, equation solver, and data serialization. Hence the amount of engineering effort makes MPWC too costly to implement. A well-to-cell coupling approach may combine the accuracy and broad applicability of MPWC with the implementation simplicity of a two-point coupling model, perhaps omitting at least some of the complexity of the model itself. In various embodiments, it may be demonstrated that the cell, which contains well perforations, hereinafter referred to as the “well-cell,” may be treated as the domain of a local boundary value problem of steady-state single-phase fluid flow. This may be solved analytically using the boundary element method (hereinafter, “BEM”) involving free-space Green's functions. Green's functions may provide the synergies that allow for solutions of the local problem to be highly sensitive to the combined geometry of the cell and the well in a computationally efficient and fast manner. In various embodiments, this solution may then be coupled to the FVM-based quantities of grid cells surrounding the well-cell, perhaps closing the local problem. The methods disclosed herein may improve MPWC by limiting the need to determine and utilize cell pressures during simulation times, perhaps allowing for a static description in terms of a single well-connection factor (i.e. two-point coupling). The new methods may allow for a potentially simpler determination before dynamic simulation starts, perhaps reducing compute power necessary to implement the methods. This may make it suitable for pre-processing software applications such as, for instance, reservoir management software (hereinafter, “RMS”), reservoir simulators, seismic simulators, and flow simulators.

The new FSWC methods may have specialized boundary conditions (hereinafter, “BCs”), including inner BCs, link BCs, and outer BCs. The BCs may be assigned to all N (or perhaps all active) link-cells 204 around the well-cell 202. Instead of the dynamic quantities Pᵢ and Qᵢ traditionally applied as outer BCs in MPWC methods, the new method may emulate an infinitely large reservoir and couple the infinitely large reservoir to the well-cell model through the link-cells while keeping the computational costs low.

“Inner BCs” may represent BCs that bound the inner LBVP domain of the well-cell 202, or, in other words, BCs that apply to the interior of the well-cell. In an embodiment, the first two lines in Eq. (18) involving well perforations (P_{w}, Q_{w}) and BEs on the well-cell (Ω₀) side (P₀ᵢ, Qᵢ) are used in one BEM Eq. (24) to solve for the unknown Q_{w}, and in n BEM Eqs. (27) to solve for n unknown P₀ᵢ values.

Another subcategory of BC may be “link BCs.” Link BCs may represent fluid flow through the link-cells 204. These boundary conditions apply to flow in the interior of the link-cells 204, for instance, in an embodiment, link-cells 204 of infinitesimal thickness. In an embodiment, Eq. (19) is used to produce n algebraic equations to solve for n unknown Qᵢ values.

Still another subcategory of BCs may be “outer BCs.” Outer BCs bound the infinite domain (Ω_{∞}) surrounding the link-cells 204 (on faces that are not shared with the well-cell 202). In an embodiment, n outer BCs are represented by the last line in Eq. (18) involving boundary elements on the infinite-domain (Ω_{∞}) side (Pᵢ, Qᵢ) used in n BEM Eqs. (29) to solve for n unknown Pᵢ values.

The existing MPWC methods employed “support flow.” Support flow represents fictitious fluid sources in the outer cells and must be determined dynamically during simulation. The new FSWC methods may adjust the inter-cell transmissibilities, perhaps using inter-cell transmissibility multipliers. This may detach the solution procedure from the dynamic model (needed in MPWC) and, perhaps, make it part of the static model with the added benefits over MPWC. This means that the features of the cells are reflected in a static model to be deployed in a dynamic simulation model, such that the solutions of the FSWC (e.g. a well connection transmissibility factor for each well-cell 202 and/or, potentially, inter-cell transmissibility multipliers for each link-cell) are determined once before the simulation starts and are used continually through the simulation, perhaps without any dynamic adjustment. This makes sense, as the most crucial factors governing intercell transmissibility (e.g. cell geometry, rock properties and other largely static factors) do not significantly change at runtime. Recalculating using support flow, as in MPWC, consumes considerable time and compute resources, so it may be advantageous to use the static inter-cell transmissibility multipliers taught with respect to the FSWC, instead.

The new methods may also account for well-placement change, using well placement optimization. The new methods may allow for continuous well placement optimizations and may be performed in more coarse simulations to provide faster dynamic measurements than those of discrete well placement optimization. This may entail not performing local grid refinements. The new methods may account for variable flow within a particular face, for instance, using a shape function.

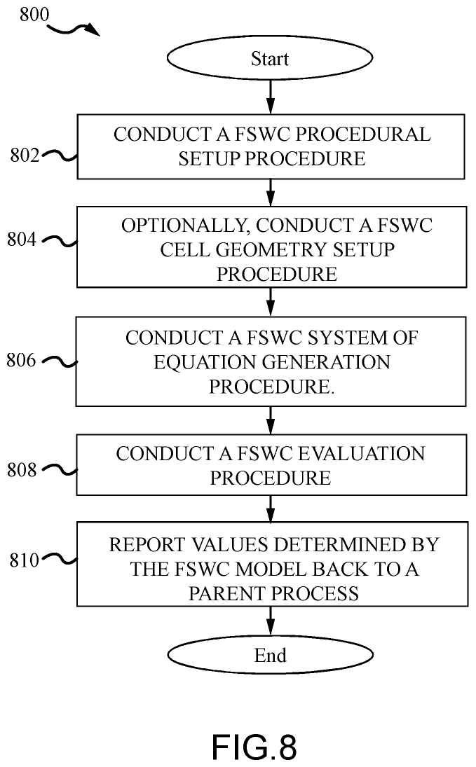

FIG. 1 shows a block diagram of an embodiment of a computer system 100 having a processor and memory for determining fluid characteristics. In various embodiments the computer system 100 may be comprised of application specific integrated circuits or may have a discrete processor and memory elements the processor elements for processing commands from and storing data on the memory elements. The computer system 100 may be an isolated physical system, a virtual machine, and/or may be established in a cloud computing environment. The computer system 100 may be configured to accomplish any method steps presented in this description, for instance, any one or combination of steps in method FIGS. 8-14. It should also be noted that the computer system 100 is configured to use none, some combination or all of procedures, equations, intermediates and variables of Refs. 1-9 in the background.

Embodiments are contemplated where specific FSWC determinations are accomplished by the computer system 100, while the other steps are accomplished by a different computer system, for instance to capitalize on greater or lesser computational power provided by the computer system 100. For instance, the computer system 100 may communicate with a cloud server to use better compute resources or to have access to better parallelization using multiple cores or graphics processing units. In an embodiment, the computer system 100 is only configured to receive data to setup and solve the equations and drive the algorithms described in this specification in order to generate FSWC output parameters to be communicated to other processes.

The computer system may have a processor 110, a memory 120, and an input/output 130. The memory 120 may store and/or may have integrated circuits representing, for instance, a modeling module 102 and/or a response module 104. In various embodiments, the computer system 100 may have other computer elements integrated into the stated elements or in addition to or in communication with the stated computer elements, for instance, buses, other communication protocols, and the like.

The processor 110 is a data processing element. The processor 110 may be any element used for processing such as a central processing unit, application specific integrated circuit, other integrated circuit, an analog controller, graphics processing unit, field programmable gate array, any combination of these or other common processing elements and/or the like. The processor 110 may have cache memory to store processing data. The processor 110 may benefit from the methods in this specification, as the methods may reduce the number and/or complexity of calculations required to output useful properties of the setting being analyzed.

The memory 120 is a device for electronic storage. The memory 120 may be any non-transitory storage medium and may include one, some, or all of a hard drive, solid state drive, volatile memory, integrated circuits, a field programmable gate array, random access memory, read-only memory, dynamic random-access memory, erasable programmable read-only memory, electrically erasable programmable read-only memory, cache memory and/or the like. The processor 110 may execute commands from and utilize data stored in the memory 120.

The computer system 100 may be configured to store any data that will be used by the modeling module 102 and/or the response module 104 and may store historical data for any amount of time representing any parameter received or used by the modeling module 102 and/or the response module 104 in the memory 120. The computer system 100 may also store any data that represents determinations of any modeling intermediates in the memory 120, perhaps with time stamps representing when the data was taken or determined. While the modeling module 102 and the response module 104 are displayed as two separate and discrete modules, the specification contemplates any number (even one or the two as specified) and variety of modules working in concert to accomplish the methods expressed in this specification.

The modeling module 102 is a module that models dynamic systems. In an embodiment, the modeling module 102 may model the behavior of a reservoir, a well, and/or a well-to-cell coupling. The modeling module 102 may carry out any operations or procedures associated with the methods presented in this specification, for instance, capabilities expressed as capabilities of the computer system 100 and the modeling module 102. All orders of the methods and abilities of the modeling module 102 are contemplated by the inventor, and the order in which these steps are presented only represent exemplary embodiments. Other embodiments may be specified, but the specification contemplates all possible orders of methods steps and carrying out of the capabilities of the modeling module 102 and the computer system 100.

The modeling module 102 may determine parameters of fluid flow for the entire system or any combination of individual elements of the system, the system perhaps including flow through porous medium, fluid flow through a well, and/or fluid flow through an interface between the well and the porous medium (e.g. a well-to-cell interface). The fluid flow through porous medium, such as reservoir rock, may be described by a phenomenological law, known as Darcy's law, relating the macroscopic fluid velocity (vector) q to the gradient of pressure p (omitting the gravitational term not relevant here),

q=−K·∇p (1)

where both p and q are functions of space x=(x, y, z) and time t. The hydraulic conductivity (tensor) K is a ratio of rock permeability k and dynamic fluid viscosity μ,

K=c_{K}k/μ, (2)

multiplied by unit conversion factor c_{K}((SI units: 0.00852702, Field units: 0.00632829). In an embodiment, k is a symmetric, positive definite tensor that captures anisotropy, the quality of having a physical property that has a different value of geologic properties (for instance, the reservoir rock due to layered deposits, channels, micro-fractures, and/or the like) when measured in different directions. Using tensor notation, K≡Kᵢⱼ with both i=1,2,3 and j=1,2,3 corresponding to the spatial coordinates x, a new tensor K_{i*j*} can be found as

$${K}_{{i}^{*} {j}^{*}} = {\sum }_{i = 1}^{3} {\sum }_{j = 1}^{3} {a}_{{i}^{*} i} {a}_{{j}^{*} j} {K}_{i j} , {i}^{*} = 1 , 2 , 3 , {j}^{*} = 1 , 2 , 3 \qquad ( 3 )$$

by aligning the rotated coordinates x* with the principal axes of the original tensor Kᵢⱼ, where a_{i*i} and a_{j*j} are the direction cosines between the two coordinate systems. With the resulting diagonal tensor

K*=diag(Kₓ*,K_{y}*,K_{z}*), (4)

obtained by mapping x [symbol] x*, another coordinate mapping x* [symbol] x° then may convert K* to the scalar K° (may be the same in all directions),

x°=x*, y°=\sqrt{Kₓ*/K_{y}*}y*, z°=\sqrt{Kₓ*/K_{z}*}z*, K°=Kₓ*, (5)

while dropping the “°” notation from K° and x° at this step. That is, in embodiments where such methods are conducted, the K° and x° values applied in the rest of the methods will be referred to as K and x despite the modification, for purposes of brevity. The modeling module 102 may be configured to evaluate relationships based on Darcy's law and solve any of the equations presented.

To dynamically simulate production from a hydrocarbon reservoir, the modeling module 102 may be configured to combine Eq. (1) with a continuity equation, representing a material balance, and further combine with an equation of state, describing fluid properties as functions of fluid composition, pressure and temperature, in order to produce a set of nonlinear partial differential equations (PDEs) which govern the multi-phase (for instance, combinations of some or all of oil, gas, water, and/or other fluids) fluid flow in the reservoir during hydrocarbon production. The modeling module 102 may determine the set of nonlinear PDEs. Given a production history or forecast, in terms of fluid flowrates and/or (bottom-hole or tubing-head) pressures in wells and groups of wells, reservoir simulation software (or reservoir simulator), perhaps including the modeling module 102, may solve the set of nonlinear PDEs by applying a numerical solution method, such as the finite volume method (FVM).

In an embodiment, the determinations of the modeling module 102 may be based on partitioning the entire domain into a grid of small sub-regions called cells, perhaps hexahedral, cubic, or other shaped, and assigning rock and fluid properties to the individual cells, together with the unknown quantities such as pressures and fluid compositions. The cells may have any 3D polyhedral shape and/or any 3D shape with polygonal faces. In another embodiment, the cells may be of any curved shape or any combination of curved and polygonal faced shapes. In an embodiment the modeling module 102 may partition domains into grids and cells. In another embodiment, the modeling module 102 may utilize an established grid with cells. In an embodiment, the domain may be a reservoir domain. The modeling module 102 may define each cell property or quantity to be spatially constant within each cell but, potentially, varying between the cells and in time during the simulated production. For the purposes of this specification, to distinguish between quantities in the continuous space (x, y, z) and the discrete space (I,J,K), where I,J,K denote grid cell indices, lower-case notation is used for the former, and upper-case notation is used for the latter. For the purposes of this specification, the index, 0, may refer to a property or quantity of the well-cell 202 being evaluated. For the purposes of this specification, the index, i, may refer to a property or quantity of a link-cell 204 that is a neighbor of the well-cell 202 being evaluated, with i values each representing a particular link-cell 204ᵢ. In the discrete space, the modeling module 102 may numerically approximate Eq. (1) for two neighboring cells 0 and i by the relationship

Qᵢ=MᵢTᵢ(P₀—Pᵢ), (6)

where Qᵢ is the fluid flowrate across face shared by the two cells. The Qᵢ may be proportional to the pressure difference between the cells. Property Tᵢ is called the (inter-cell) transmissibility and it is a function of geometry and rock permeability of the two cells. The coefficient Mᵢ is the inter-cell transmissibility multiplier and its default value may be 1. The modeling module 102 may adjust the Mᵢ value, as described below. In an embodiment, another property, called fluid mobility (and consisting of: fluid viscosity μ, relative rock permeability of multi-phase fluid flow, and so-called formation volume factor), may be omitted from Eq. (6). In an embodiment, the modeling module 102 may omit the fluid mobility from the determination of flowrate Qᵢ.

Wells drilled through the reservoir domain may intersect several grid cells along the well trajectories. Selected tubing segments in these wells may be perforated to allow fluid to flow between the wells and the reservoir. Some wells may retrieve reservoir fluid (by applying low pressure), while other wells may inject water or other fluid (by applying high pressure) to displace reservoir fluid towards the producing wells. For demonstration purposes, it may be more convenient to consider an embodiment of injection wells, but all steps, for instance steps carried out by the modeling module 102, may be equally applicable to production wells, too.

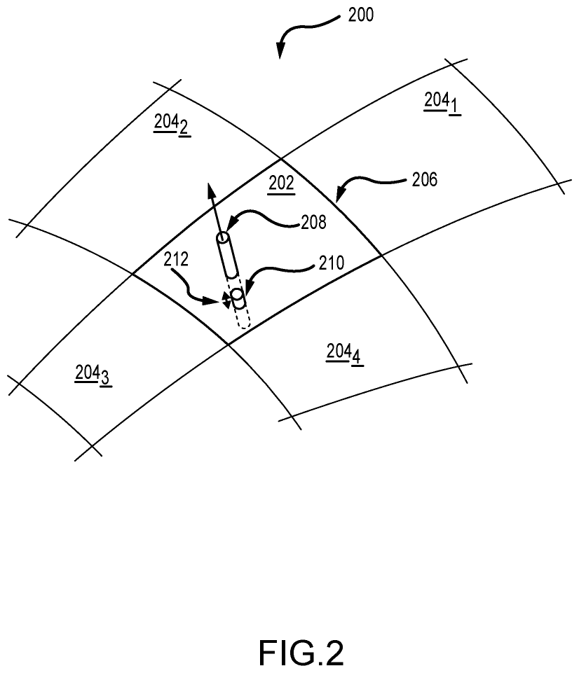

FIG. 2 shows a rendition of an embodiment of a system portion 200 of an FVM grid with a well-cell 202 surrounded by link-cells 204. The modeling module 102 of FIG. 1 will be further disclosed in the context of FIG. 2. FIG. 2 is not a separate embodiment from FIG. 1 but merely represents an image to teach features of the embodiments of the modeling module 102 and/or the computer system 100 from FIG. 1, as well as the methods disclosed. In an embodiment, the system portion 200 may have a well-cell domain 202, a first link-cell domain 204₁, a face 206 (hereinafter referred to as “face Γᵢ” as an example of each of the faces of each link, i, to well-cell interface area), wellbore 208, perforation 210, perforation segment 212, second link-cell 204₂, third link-cell 204₃, and fourth link-cell 204₄. For the purposes of this specification, specific individual link-cells can generally be referred to as link-cell 204ᵢ for a link-cell with reference, “i.” It can be appreciated that, because of the two-dimensional nature of the figure, what would be link-cells 204₅ and 204₆ are not shown. Embodiments where the cells have differing shapes between the cells and/or have differing geometries from those specified in this specification are contemplated, such that each well-cell 202 may have number(s) of neighboring link-cells 204ᵢ different from the six shown in the Figures.

For each well-cell 202, one may define a local cell array that represents the well-cell 202 and link-cells-204 with which the well-cell 202 shares a face. This local cell array may be treated as an independent unit when solutions to the FSWC model are determined, except to the extent that adjacent well-cells 202 each have values that may need to be resolved (e.g. determining transmissibilities when between a face shared by two well-cells 202; in such an instance, the final transmissibility of that face may be resolved by averaging or other method). The local cell array may also be referred to as the N+1 cells (with the N cells representing the link-cells 204 and the 1 cell representing the well-cell 202).

The system portion 200 is a portion of a well, reservoir cell and an interface between them. The system portion 200 is merely representative of a larger model. It should be understood that such a portion is merely representative of an interface between a single perforation and its interaction with its environment.

The well-cell domain 202 is a domain of a cell, here represented in two dimensions, in which a well perforation is situated. It should be appreciated that these cells are actually three-dimensional. The well-cell domain 202 may also be denoted as well-cell Ω₀ or 202. The well-cell 202 may be modeled as having a particular mass balance of fluid entering and leaving the well-cell 202 at steady state. Quantities referencing the well-cell domain 202 or representing properties of the well-cell domain 202 may frequently be represented with a subscript “0.” For instance, the well-cell domain 202 may have pressure P₀ and/or pressure on face P₀ᵢ. It can be seen that the well-cell domain 202 can be of any shape, including the shape demonstrated in the embodiment shown or hexahedral instead of the shapes shown. Cubic cells are also contemplated. Cells of any three-dimensional shape with polygonal and/or curved faces and/or edges are contemplated. These shapes can also represent the shapes of each of the link-cells 204ᵢ and well-cells 202. It should also be noted that the dimensions of cells may vary from one cell to another.

The link-cell domain 204 is the domain representing a cell, here represented in two dimensions, adjacent to and that has a common face with the well-cell 202. The link-cell domain 204 may also be referred to as the link-cell Ωᵢ or 204. For the purposes of explanation, the link-cell domain 204 and the cell Ωᵢ it represents may be called the link-cell 204, generally, and may have routines and properties that are common to all link-cells 204 (or all active link-cells 204 in relevant embodiments) and their interactions with the well-cell 202. References to a particular link-cell domain 204 may be denoted with a subscript “i.” For instance, the first link-cell 204 could be referenced as i=1, with notation, 204₁. Each link-cell 204ᵢ may represent the direct link between the well-cell 202 and the rest of the reservoir grid. It should be recognized that the specification contemplates scenarios where certain cells are not accounted for, in which all cells are accounted for, and in which a perforation has no flow through it due to low or no porosity or permeability of surrounding rock. A link-cell 204 may have a flow from the well-cell Qᵢ, a link-cell pressure Pᵢ, a cell face Γᵢ, and the like. For the purposes of the specification, it may be assumed that the flow entering a link-cell 204 from a well-cell 202 is equal to the flow out of the link-cell 202, to one, some or all of the link-cells' 204 other faces.

The face 206 is an example of each of the faces Γᵢ of the link-cell to well-cell interface areas for which computations may be conducted (though their quantities likely differ). The face 206 is an area of interface between the well-cell domain 202 and the link-cell domain 204. It should be appreciated that each of the link-cells 204, will have a face Γᵢ 206 whose quantities may be determined similarly to those of the exemplary link-cell 204.

The wellbore 208 is a wellbore that transports fluids two or from the ground. In an embodiment, the wellbore 208 is used to introduce fluids to a reservoir to compel other fluids to the surface for retrieval, as in an injection well. The wellbore 208 may pull fluids from a reservoir, as in a production well.

The perforation 210 is a perforation in the wellbore that allows fluids to be retrieved from or introduced to the reservoir. For purposes of the specification, the perforation 210 may be called perforation Γ_{w}. The perforation Γ_{w} may have a perforation interval 212. A perforation segment 212 is a segment along the well trajectory representing an opening between the well's inner tubing and the reservoir rock. In an embodiment, the perforation may be cylindrical (e.g. with each perforation being small cylinders of certain length (part of Λ_{w}) and radius (r_{w})), but all perforation intervals 212 in the art are contemplated. The well perforation may span over a certain surface area to model “hydraulically fractured wells” or wells connected to natural fractures that conduct fluid. FSWC may be easily applied to well-to-cell coupling of hydraulically fractured wells. In FSWC, well perforations of hydraulically fractured wells may be modelled using (polygonal) BEs already supported for the well-cell faces in existing software. In existing simulation code, one may assign some pressure P_{w}, to hydraulically fractured well BEs, and fluid may be injected like through “normal” perforations.

The model is two-dimensional and contemplates the shown second link-cell 204₂, third link-cell 204₃, and fourth link-cell 204₄, which have properties similar to the link-cell 204. It should be recognized that, in three dimensions, in the model represented by the image shown that there would also be link-cells 204 above and below the well-cell domain 202, each having a face in common with the well-cell domain 202, and having similar relationships to the well-cell domain 202 quantities and determinations.

Referring to FIG. 2, the cell in the middle contains one or more well perforations Γ_{w}; let the cell be called the well-cell 202. Furthermore, let all the cells i=1, . . . , 6 directly attached to the well-cell 202 at faces Γᵢ be called the link-cells 204 for easy reference (as they may represent the direct links between the well-cell 202 and the rest of the reservoir grid). Note that FIG. 2 only shows four of the six link-cells 204 that would be presented in this embodiment in three-dimensional space. Any link-cell 204 may also contain well perforations; any link-cell 204 with well perforations may thus become “well-cells” 202 in another iteration and may be evaluated in that iteration in the same manner as the present well-cell 202 when the method proceeds, in turn, from the present well-cell 202 to other well-cells, until the aforementioned link-cell 204 becomes the relevant well-cell 202.

Fluid flow inside wells, between the bottom-hole perforations and the tubing head at surface, may be described and/or evaluated by additional equations capturing pressure drop along the wellbore 208 due to gravity, friction, acceleration, etc. The modeling module 102 may evaluate these equations, known as the well model, by solving for one or more of unknown quantities, for instance, wellbore pressure P_{w} and total flowrate Q_{w} (perhaps for many wells, even for hundreds or thousands of wells). In a full dynamic reservoir simulation run, the modeling module 102 may solve the PDEs that model the reservoir flow, also known as a reservoir model, for their unknown quantities (often millions or even billions in total), including the cell pressures P_{i=0, . . . ,6} of the cells illustrated in FIG. 2. To mathematically combine the well model with the reservoir model in a single set of equations to be processed by the modeling module 102 and/or reservoir simulator, the so-called well-to-cell coupling may be formulated as an expression involving well quantities {P_{w}, Q_{w}} and cell pressures Pᵢ. A two-point coupling formula, used here by the modeling module 102, may contain only the well-cell pressure P₀,

Q_{w}=T_{w}(P₀−P_{w}), (7)

whereas a multi-point coupling formula [Ref. 6], used elsewhere [Refs. 4 and 5], includes also the link-cell pressures P_{i>0},

$${Q}_{w} = {\sum }_{i = 0}^{N} {C}_{i} {P}_{i} - {C}_{w} {P}_{w} . \qquad ( 8 )$$

Parameter T_{w} in Eq. (7) is called the well connection transmissibility factor, or just connection factor (sometimes also referred to as well index). With the procedures of the FSWC method, the parameter T_{w} can be determined by the modeling module 102 and may reflect asymmetries in pressure and flow distributions around wells within cells. The modeling module 102 may determine the value of T_{w} in Eq. (7), along with the values of M_{i=1, . . . ,N} in Eq. (6).

Referring to FIG. 2, an embodiment of the invention may contemplate a “flow experiment” by specifying injection pressure P_{w} and letting the injected fluid flow from well perforations Γ_{w}, through the well-cell 202 towards its boundaries Γᵢ, and further through the link-cells 204 to their outer faces connected with the rest of the reservoir grid. In this embodiment the rest of the reservoir grid may be replaced by a simplified model which emulates its behavior, for example an “infinitely large” reservoir. By doing so, one can effectively form an isolated system of N+1 cells (i.e. a local cell array) in which the injected fluid flows freely through them. The infinitely large reservoir assumption may assume that the cells outside of each local cell array being evaluated are composed of porous rock with the same permeability as the well-cell 202. This system may represent a local boundary value problem (LBVP) which may be solved, by the modeling module 102, for the N+1 unknown cell pressures P_{i=0, . . . ,N} by supplying N+1 (linearly independent) equations involving them.

The mathematical isolation of the local system can be justified by accepting the superposition principle under the assumption of linear (or weakly nonlinear) response. The modeling module 102 can treat each well-cell 202 separately, and the well's (positive or negative) contribution can be added, by the modeling module 102, to the total material balance in sequence.

As demonstrated elsewhere [Ref. 6], a very powerful solution technique for the local flow problem under consideration is the boundary element method (BEM), involving free-space Green's functions which represent analytical solutions of the “adjoint problem”. Two simplifying assumptions may be built into the problem formulation: 1. single-phase fluid, and 2. steady-state flow. Such assumptions are usually adopted in the majority of other well-to-cell coupling approaches, including the Peaceman formula [Refs. 1, 2, and 3]. Unlike the Peaceman coupling formula, however, the embodiment of the model employed by the modeling module 102 makes no assumption of symmetry in the pressure field around the well perforations.

The modeling module 102, may combine the mass conservation of the flowing fluid at steady state with Eq. (1) of Darcy's law, to yield the basic PDE known as the Poisson equation:

∇·(K·∇p)=−σ, x∈Ω₀, (9)

where Ω₀ is the domain of cell 0 (the well-cell 202) and a represents fluid sources or sinks in Ω₀. After the Cartesian coordinates mapping of Eqs. (3) and (5), and recalling that rock properties are constant over FVM cells, Eq. (9) may be simplified to

K∇²p=−σ, x∈Ω₀. (10)

As a special case, the distributed internal source a may be reduced to a point source at x′, for which Eq. (10) becomes

K∇²G=−δ(x−x′), x∈Ω₀, (11)

where δ is the Dirac's delta function, x′ is called the source point (or singular point), and G(x, x′) is the free-space Green's function that represents a fundamental solution of the adjoint problem defined by Eq. (11). As G corresponds to the pressure p, there may also be a function corresponding to the velocity q defined in Eq. (1):

F=−K∇G (12)

On the boundary of the problem domain, Γ₀=∂Ω₀, described by its outward normal unit vector \hat{n}(x ∈ Γ₀), the normal components of q and F are simply

q=q·\hat{n}, F=F·\hat{n}. (13)

Then, using the Euclidean distance r(x, x′) between the source point x′ and any field point x,

r=|x−x′|=\sqrt{(x−x′)²+(y−y′)²+(z−z′)²}, (14)

the functions G (x, x′) and F (x, x′), sometimes also referred to as G- and F-kernels, are defined as:

$$G = \frac{1}{4 π K r} , F = \frac{- d}{4 π {r}^{3}} , \qquad ( 15 )$$

where d≡(x−x′)·\hat{n} is the distance of point x′ from the polyhedral boundary Γ₀=Uᵢ₌₁^{N}Γᵢ.

In order for the modeling module 102 to solve Eq. (10), one can exclude the entire wellbore from the well-cell domain Ω₀ and make its perforations Γ_{w} a part of the well-cell boundary Γ₀:

$${Γ}_{0} = {Γ}_{w} ⋃ {{⋃}^{N}}_{i = 1} {Γ}_{i} , \vert {Γ}_{w} \vert ≅ 2 π {r}_{w} {L}_{w} , {L}_{w} = \vert {Λ}_{w} \vert , \vert {Γ}_{i} \vert = {A}_{i} . \qquad ( 16 )$$

In Eq. (16), r_{w} is the wellbore radius, L_{w} is the total length of all perforation segments Λ_{w} along the well trajectory, and Aᵢ is the area of face i. Flow-rate Qᵢ across each face i may be taken, using the modeling module 102, to approximate the total normal flux across Γᵢ, while the sum of Qᵢ's over all well-cell 202 faces may be equal (with opposite sign) to the total well flowrate Q_{w}:

$${Q}_{i} \approx {\int }_{{Γ}_{i}} q d γ , {Q}_{w} = - {\sum }_{i = 1}^{N} {Q}_{i} . \qquad ( 17 )$$

Based on Eq. (17), the boundary conditions (BCs) for the local boundary value problem may then be formulated as:

p=P_{w}, q=c_{w}Q_{w}, for x∈Γ_{w},

p=P₀ᵢ, q=cᵢƒQᵢ, for x∈Γ_{w}=∂Ω₀∩∂Ωᵢ≡Γ₀ᵢ,

p=Pᵢ, q=−cᵢƒQᵢ, for x∈Γ_{w}=∂Ωᵢ∩∂Ω_{∞}≡Γ_{i∞}. (18)

Coefficients c_{w} and cᵢ are defined later, see Eq. (26). The “shape function” ƒ(x, x′) describes the distribution of flux q over each face Γᵢ; the choice of its particular form, perhaps specified or determined by the modeling module 102, is one of the tuning options for the claimed method. The face pressure P₀ᵢ is the pressure on the well-cell (Ω₀) side of face Γᵢ, after each link-cell is replaced by a thin layer of porous media, while preserving the original transmissibility MᵢTᵢ.

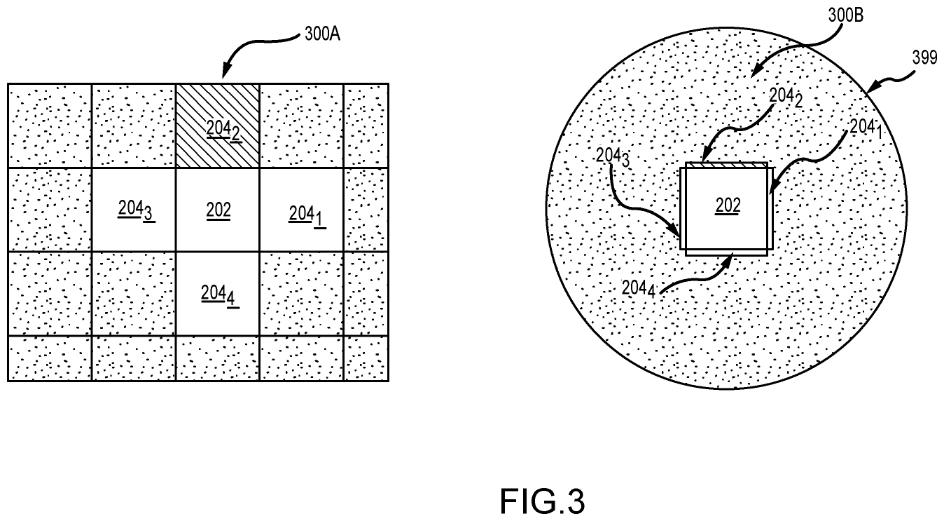

FIG. 3 shows a block diagram of an embodiment of a comparison of how an original FVM model appears relative to a corresponding converted LBVP model. In this embodiment, the models may focus on a single well-cell 202 and its neighboring link-cells 204; (here shown as 204₁₋₄ because of the two-dimensional nature of the image). Image 300A shows a grid model as an example of an FVM model. In 300A, grid cell 204₂ is shown as having a different pattern, indicative of cell 204₂ being inactive. Image 300B shows an embodiment of the LBVP model equivalent of the embodiment shown in Image 300A. The grid of Image 300A surrounding the link-cells 204 may be replaced in the LBVP model by an infinitely large domain of image 300B, and the link-cells 204 in the LBVP may be collapsed into infinitesimally thin layers covering the well-cell 202. Despite image 300B illustrating a boundary it should be understood that the boundary is a remote boundary of an infinite domain 399. Pressure drop between the inner (Γ₀ᵢ) and outer (Γ_{i∞}) faces may be proportional to the flowrate Qᵢ across the thin layer of transmissibility T_{0i,i},

Qᵢ=T_{0i,i}(P₀ᵢ−Pᵢ), (19)

while the relation between the inter-cell (Tᵢ) and half-cell (T_{0i,i}) transmissibilities may be described by the harmonic sum:

Tᵢ=(1/T_{0,0i}+1/T_{0i,i})⁻¹ (20)

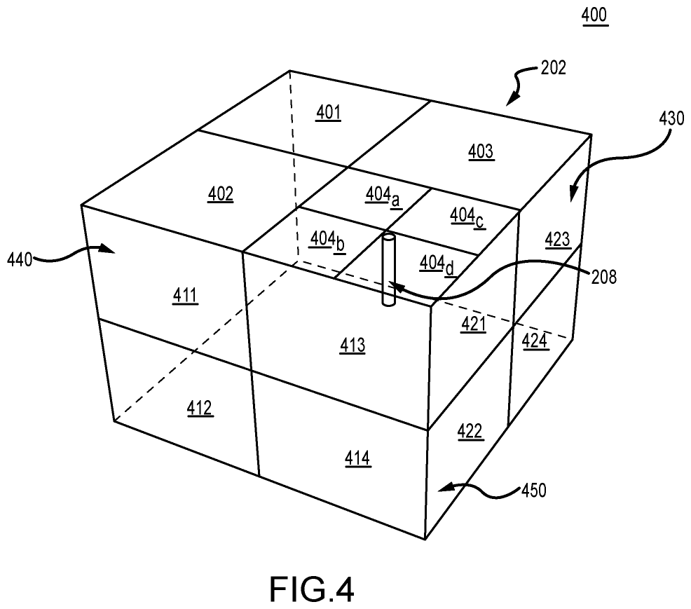

For N link-cells, and a prescribed P_{w} value, the BC Eqs. (18) introduce 3N+1 unknowns: Q_{w}, P₀ᵢ, Qᵢ and Pᵢ. To determine the unknowns, using the modeling module 102, the same number of equations may be generated and solved. As shown below, 2N+1 of those may come from the BEM integral equations, while the other N equations may include the Robin type (mixed) BC of Eq. (19) for active link-cells, or the Neumann type (no flow) BC, Qᵢ=0, for inactive link-cells 204. It should be added that other BC types may also be applied by the modeling module 102, for example a Dirichlet type BC assigning pressure values to Pᵢ directly. However, the suggested “infinite domain” BC for the outer (Γ_{i∞}) faces may yield the most accurate and stable results, and its implementation in BEM is extremely easy and cheap because the modeling module 102 may just reverse the face orientations by changing the signs of F-kernel integrals already computed for the inner (Γ₀ᵢ) faces. Numerical experiments show that the accuracy of BEM-based solutions of LBVP may improve drastically when the well-cell 202 faces closer to well perforations (according to some measure of distance relative to the face size) are split into more boundary elements, an embodiment of which is illustrated in FIG. 4.

The BC types may be subdivided into categories based on the geometric elements to which the BCs apply. For instance, “inner BCs” may represent BCs that bound the inner LBVP domain of the well-cell 202, or, in other words, BCs that apply to the interior of the well-cell. In an embodiment, the first two lines in Eq. (18) involving well perforations (P_{w}, Q_{w}) and BEs on the well-cell (Ω₀) side (P₀ᵢ, Qᵢ) are used in one BEM Eq. (24) to solve for the unknown Q_{w}, and in n BEM Eqs. (27) to solve for n unknown P₀ᵢ values. This geometric element may be further referred to as the “inner layer”.

Another subcategory of BC may be “link BCs.” Link BCs may represent fluid flow through the link-cells 204. These boundary conditions apply to flow between the inner (Γ₀ᵢ) and outer (Γ_{i∞}) faces of link-cells 204, for instance, in an embodiment, link-cells 204 of infinitesimal thickness. In an embodiment, Eq. (19) is used to produce n algebraic equations to solve for n unknown Qᵢ values. The corresponding geometric element may be further referred to as the “link layer”.

Still another subcategory of BCs may be “outer BCs.” Outer BCs bound the infinite domain (Ω₀) surrounding the link-cells 204 (on faces that are not shared with the well-cell 202). In an embodiment, n outer BCs are represented by the last line in Eq. (18) involving boundary elements on the infinite-domain (Ω₀) side (Pᵢ, Qᵢ) used in n BEM Eqs. (29) to solve for n unknown Pᵢ values. The corresponding geometric element may be further referred to as the “outer layer”.

FIG. 4 shows a perspective view 400 of an embodiment of a well-cell 202 in which well-cell faces are split into more boundary elements. In an embodiment, the faces are split more when closer to a well perforation. The well-bore 208 is located within the well-cell 202. The well-cell 204 has more refined boundary elements near the location of the well perforation in the well-bore 208. The well-cell 202, as shown, has the top face further refined into boundary elements 401 to 404, with the well-bore being closest to the boundary element 404, boundary element 404 further divided into boundary elements 404_{a-d}. This gives the top portion 7 total boundary elements. The front two sides, represented by faces, one face having boundary elements 411-414 and the other face having boundary elements 421-424. This gives each of the front two faces each four boundary elements for a total of eight boundary elements. It can be appreciated that these front two sides are further divided than sides 430, 440, and 450, as the front two sides are closer to the well-bore 208 and its perforation than sides 430, 440, and 450. Sides 430, 440, and 450 are not further subdivided, meaning each of the faces has 1 boundary element, for a total of 3 boundary elements. With the seven boundary elements from the tope face, the eight boundary elements from the two front faces, and three boundary elements from the remaining faces, this embodiment has 18 total boundary elements. This embodiment of the model may be referred to in different parts of the specification, but the number of boundary elements is not limited.

Denoting n the total number of boundary elements (BEs), the example in FIG. 4 would then have N=6 link-cells and n=18 BEs. The modeling module 102 can substitute N with n in almost all the relevant equations introduced so far, and they would remain valid. Exceptions to this may be the calculation of P₀, T_{w} and Mᵢ, see Eqs. (30) and (33), which may apply exclusively to link-cells (i=1, . . . , N), not boundary elements.

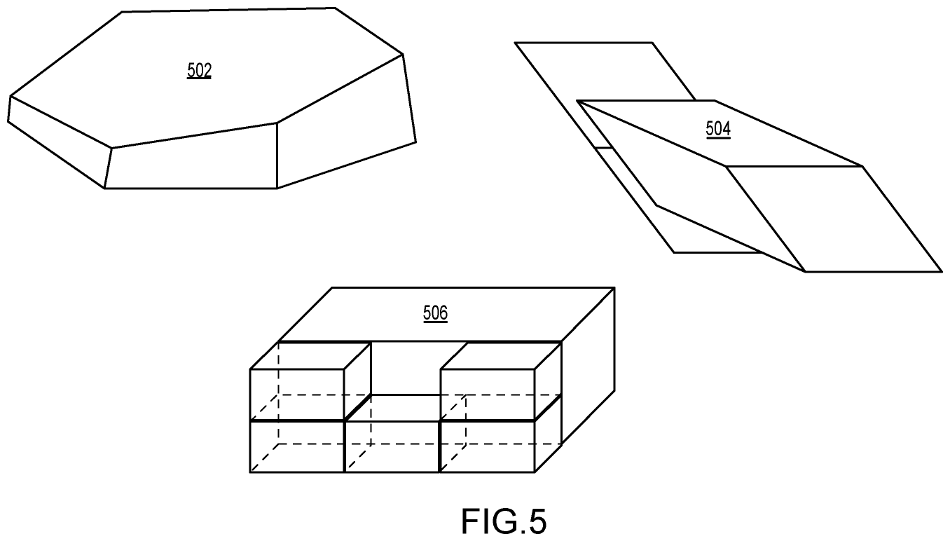

FIG. 5 shows perspective views of embodiments of different cell geometries. In various embodiments, the cells may be of different shapes and conformations such that the number of faces can vary. Image 502 shows an embodiment of a non-hexahedral well-cell. Image 504 shows an embodiment of a shifted well-cell, for instance, along a geological fault. Image 506 shows an embodiment of a well-cell 202 attached to a local grid refinement (hereinafter, “LGR”). It can be appreciated that, as shown, image 506 shows an omitted grid cell, the omitted grid cell representing an inactive LGR cell. The inactivity may be a result of small pore volume, small transmissibility, and/or an outer edge of the grid. If a link-cell 204, is inactive, the corresponding flowrate, Qᵢ, in Eq. (6) may be set to zero. These are merely examples of cell geometries, and any other geometry is contemplated by this specification.

The BEM-based solution of the boundary value problem under consideration may be derived from Green's second identity,

$$\int {\int }_{Ω} \int ( p ∇ \cdot F - G ∇ \cdot q ) d ω = {\int \int }_{Γ} ( p F - G q ) \cdot \hat{n} d γ , \qquad ( 21 )$$

together with Eqs. (10)-(13), as follows:

$${c}_{c} ( {x}^{′} ) p ( {x}^{′} ) = {\int }_{Γ} [ p ( x ) F ( x , {x}^{′} ) - q ( x ) G ( x , {x}^{′} ) ] d γ ( x ) . \qquad ( 22 )$$

The “contact coefficient” c_{c} captures connectivity/completeness of the local domain around the source point x′. For the boundary conditions formulated in Eq. (18), and consistent with the wellbore excluded from the well-cell domain Ω₀, whereby setting c_{c}=0, Eq. (22) becomes:

$${\int }_{{Γ}_{w}} ( {P}_{w} F - {c}_{w} {Q}_{w} G ) d γ + {\sum }_{i = 1}^{n} {\int }_{{Γ}_{i}} ( {P}_{0 i} F - {c}_{i} {Q}_{i} fG ) d γ = 0. \qquad ( 23 )$$

Eq. (23) describes a relationship between well quantities {P_{w}, Q_{w}} and cell quantities {P₀ᵢ, Qᵢ} for a single source point x′ within the perforated interval Λ_{w} of the well trajectory (outside Ω₀). To satisfy Eq. (23) for every point x′ ∈ Λ_{w}, the following must hold:

$${\int }_{{Λ}_{w}} {I}_{w} d λ + {\sum }_{i = 1}^{n} {\int }_{{Λ}_{w}} {I}_{i} d λ = 0 , \text{} {I}_{w} = {\int }_{{Γ}_{w}} ( {P}_{w} F - {c}_{w} {Q}_{w} G ) d γ , \text{} {I}_{i} = {\int }_{{Γ}_{i}} ( {P}_{0 i} F - {c}_{i} {Q}_{i} fG ) d γ . \qquad ( 24 )$$

Integrals I_{ww}=∫_{Λ}_{_{w}}I_{w}dλ and Iᵢ can be evaluated analytically by the modeling module 102, whereas integrals I_{wi}=∫_{Λ}_{_{w}}Iᵢdλ have no closed-form expression and may be approximated numerically by the modeling module 102, e.g. using the Gaussian quadrature (GQ),

$${\int }_{{Λ}_{w}} {I}_{i} ( {x}^{′} ) d λ ≅ {\sum }_{k} {ψ}_{k} {I}_{i} ( {x}_{Λ -} + {χ}_{k} ( {x}_{Λ +} - {x}_{Λ -} ) ) , \qquad ( 25 )$$

where {χₖ,ψₖ}∈ (0,1) is the k^{th} GQ abscissa—weight pair, and {x_{Λ-}, x_{Λ+}} are the lower & upper limits of a single well perforation segment from Λ_{w}. With a similar integral approximation involving the shape function ƒ(x, x′), the coefficients c_{w} and cᵢ, appearing in Eqs. (18), (23) and (24), may be expressed as

$${c}_{w} = \frac{{c}_{Q}}{2 π {r}_{w} {L}_{w}} , {c}_{i} = {{c}_{Q} ( {\sum }_{k} {ψ}_{k} {\int }_{{Γ}_{i}} f ( x , {x}^{′} ( {χ}_{k} , {Λ}_{w} ) ) d γ ( x ) )}^{- 1} , \qquad ( 26 )$$

where c_{Q} is a unit conversion factor (SI units: 1.0, Field units: 5.614583). If q was assumed uniformly distributed over Γᵢ by setting ƒ=1, its coefficient would simplify to cᵢ=c_{Q}/Aᵢ.

Only one Eq. (24) can be constructed, using the modeling module 102, producing integrals I_{ww} and I_{wi}, and hence it is convenient to associate it with the single unknown: Q_{w}. To solve for the n unknown pressures P₀ᵢ, by the modeling module 102, the source point x′ is then gradually moved onto each face (or boundary element) Γᵢ, which thus replaces the integration domain Λ_{w} in Eq. (24),

$$for {x}^{′} ∈ {Γ}_{0 i} : {\int }_{{Γ}_{i}} {I}_{w} d γ + {\sum }_{j = 1}^{n} {\int }_{{Γ}_{i}} {I}_{j} d γ = \frac{1}{2} {P}_{0 i} , \qquad ( 27 )$$

forming n pairs of new integrals I_{iw} and Iᵢⱼ. Since the source point now belongs to the boundary, i.e. it may no longer be excluded from Ω₀ ∩ Γ₀ as in Eqs. (23) and (24), the contact coefficient c_{c} may become 0.5, and the corresponding face pressure term may appear on the right-hand-side of Eq. (27). As before, the integrands I_{w} and Iⱼ, defined in Eq. (24), may be evaluated analytically, by the modeling module 102, whereas the integrals over Γᵢ in Eq. (27) may be approximated numerically by the modeling module 102. In this case, the Gaussian quadrature may be applied twice:

$${\int }_{{Γ}_{i}} I ( {x}^{′} ) d γ ≅ {\sum }_{k} {\sum }_{l} {ψ}_{k} {ψ}_{l} I ( x ( {χ}_{k} , {χ}_{l} ) ) J ( {χ}_{k} , {χ}_{l} ) . \qquad ( 28 )$$

The spatial vector function x(χₖ, χᵢ) may describe the geometry of polygon Γᵢ using a bilinear interpolation between the two local coordinates χ ∈ (0,1), while J(χₖ, χᵢ) is the Jacobian (determinant) of the coordinates mapping x [symbol] χ. Note that the coefficient cᵢ appearing implicitly in Eq. (27) via Iⱼ, see its definition as Iᵢ in Eq. (24), is now computed using Eq. (26) modified by replacing Λ_{w} with Γᵢ and doubling the GQ summation as in Eq. (28). All intermediates and expressions shown may be evaluated by the modeling module 102.

To solve, by the modeling module 102, for the n unknown “outer” pressures Pᵢ, a set of n equations analogous to Eqs. (27) may be formulated as:

$$for {x}^{′} ∈ {Γ}_{i ∞} : {\sum }_{j = 1}^{n} {\int }_{{Γ}_{i}} {I}_{j} d γ = \frac{1}{2} {P}_{i} , with F ( d ) \to F ( - d ) , \qquad ( 29 )$$

where d is distance. The system of BEM Eqs. (29) therefore differs from the BEM Eqs. (27) only in two aspects: 1. no I_{w} term, and 2. reversed F-kernel sign.

Finally, to determine, by the modeling module 102, the n unknown flowrates Qᵢ, up to n Eqs. (19) are constructed by the modeling module 102 for all boundary elements attached to active link-cells 204. For inactive link-cells 204, the no-flow condition Qᵢ=0 is applied instead. This completes the global system of 3n+1 linear algebraic equations, which is subsequently resolved to find the values of Q_{w}, Qᵢ, P₀ᵢ and Pᵢ for the prescribed value of P_{w}.

An overall objective of the method disclosed as embodiments herein is to determine, by the modeling module 102, the values of T_{w} in Eq. (7) and Mᵢ in Eq. (6), such that they reflect relations among the boundary values of P and Q just found. The key quantity appearing in both equations is the well-cell pressure P₀; this needs to be determined first. However, since Mᵢ refers to link-cells (204ᵢ), whereas Pᵢ and Qᵢ (temporarily denoted as P̅ᵢ and Q̅ᵢ) currently describe boundary elements (i=1, . . . , n≥N), the latter may be incorporated into the corresponding link-cell 204 quantities:

$${P}_{i} = \frac{1}{{A}_{i}} {\sum }_{j ∈ {𝔼}_{i}} {A}_{j} {\overline{P}}_{j} , {Q}_{i} = {\sum }_{j ∈ {𝔼}_{i}} {\overline{Q}}_{j} , i = 1 , … , N . \qquad ( 30 )$$

Indices i and j refer, respectively, to link-cells and BEs, and [symbol] ᵢ is a set of BE indices belonging to link-cell face i. For example, the front face in FIG. 4 has [symbol] ᵢ={6, 7, 8, 9}. At this point, it is convenient to introduce two additional sets of indices, [symbol] and [symbol] , representing active and inactive link-cells, respectively:

$$for i = 1 , … , N : \{ \begin{matrix}i ∈ 𝔸 if {T}_{i} \geq {ε}_{T} ∧ {\tilde{V}}_{i} \geq {ε}_{V} ; & active link - cell \\ i ∈ 𝕀 if {T}_{i} < {ε}_{T} ∨ {\tilde{V}}_{i} < {ε}_{V} ; & inactive link - cell\end{matrix} , \qquad ( 31 )$$

where ε_{T} and ε_{V} are some prescribed threshold values for the inter-cell transmissibility Tᵢ and cell pore volume V̅ᵢ, respectively. The total numbers of active and inactive link-cells are then:

[symbol]

=| [symbol] |, [symbol] =| [symbol] |, [symbol] >0, [symbol] + [symbol] =N (32)

Obviously, inactive link-cells have no meaningful Eq. (6), so one could simply set: Mᵢ=0, i ∈ [symbol] .

One way to find the value of P₀ that satisfies Eq. (6) for all [symbol] active link-cells is to express Mᵢ by means of Eq. (6) and sum up its values to yield [symbol] , as follows:

$${\sum }_{i ∈ 𝔸} \frac{{Q}_{i}}{{T}_{i} ( {P}_{0} - {P}_{i} )} = {N}_{𝔸} . \qquad ( 33 )$$

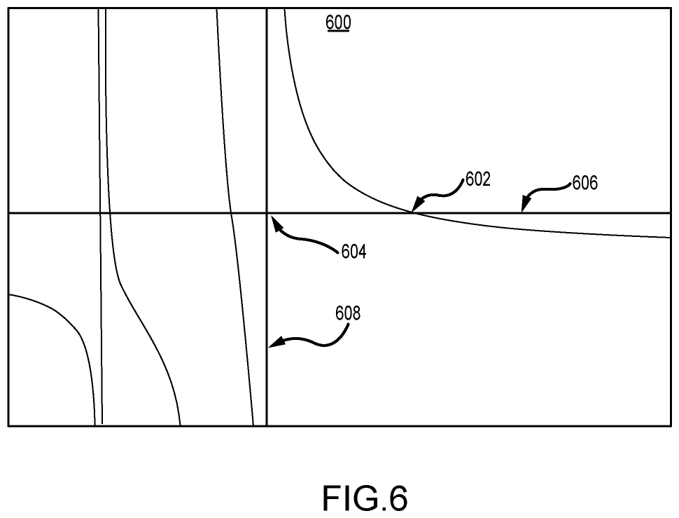

Plotting the residual of Eq. (33) against P₀ for the well-cell shown in FIG. 4 reveals an interesting pattern shown in FIG. 6.

FIG. 6 shows a graph 600 of an embodiment of a comparison of the residual of Eq. (33) against P₀ for the well-cell 202 shown in FIG. 4. Graph 600 may have a valid largest root 602, a point 604 of maximum Pᵢ from which positive pressures can be derived, abscissa 606 representing the P₀ variable, and an ordinate 608 corresponding to the residual of Eq. (33). The four poles in the plot represent four different Pᵢ values, reduced from six due to mirror symmetry in the example setup. The single physically acceptable solution for P₀ to be determined by the modeling module 102 is the one that ensures all Mᵢ values are positive. In this embodiment, the largest root 602 may be the only acceptable solution.

In an embodiment, a Newton iterative search method may be used by the modeling module 102 to locate the largest root, starting just above the maximum Pᵢ value from all the link-cells. In different embodiments, the modeling module 102 may use root finding algorithms other than the Newton iterative search method.

Eq. (33) may be seen as a “gauge condition,” perhaps ensuring that, whatever asymmetry appears in the initial values of Tᵢ and in the computed values of Pᵢ and Qᵢ, the sum of all Mᵢ values resulting from Eq. (6) is always equal to [symbol] . Two extreme cases may be considered as test examples:
1. Point-shaped well perforation in the centre of a cube-shaped well-cell with all six link-cells of identical properties: there is effectively no asymmetry and hence M_{i=1, . . . ,N=6}=1, giving ΣᵢMᵢ=6= [symbol] .
2. Any well perforation in any well-cell with only one link-cell active (out of all N), i.e. [symbol] =1: this is the most severe asymmetry, resulting in [symbol] values [symbol] =0 and one value [symbol] =1, giving ΣᵢMᵢ=1= [symbol] .

The majority of real cases may fall between these two extreme cases, with some of their inter-cell transmissibility multipliers Mᵢ<1 and others Mᵢ≥1, but always giving ΣᵢMᵢ= [symbol] . Eq. (33) may ensure this constraint by allowing a determination of a single unique value of the unknown P₀ which satisfies both ΣᵢMᵢ= [symbol] and [symbol] >0, while the latter corresponds to P₀> [symbol] .

Once the P₀ value is known, it is just a straightforward application of Eqs. (7) and (6) for the modeling module 102 to obtain the final values of T_{w} and M_{i=1, . . . ,N}.

Any asymmetry in the well-cell shape and/or well perforations' shape, location, or distribution within the well-cell may lead to numerical differences among the computed values of boundary integrals in Eqs. (24), (27) and (29), the first two involving inner BCs and the last one involving outer BCs. Furthermore, additional asymmetry in rock permeability and geometry of all link-cells around the well-cell, perhaps reflected in their half-cell and inter-cell transmissibilities, may produce numerical differences in the corresponding Eqs. (19) of their link BCs. All this may contribute to variations among coefficients of the unknown quantities P₀ᵢ, Pᵢ and Qᵢ, associated with n boundary elements, producing a numerical asymmetry in the set of equations represented by matrix A and the solution vector X, eventually affecting the resulting values of T_{w} and Mᵢ.

Table 1 below provides a table of symbols and an embodiment of their respective meanings.

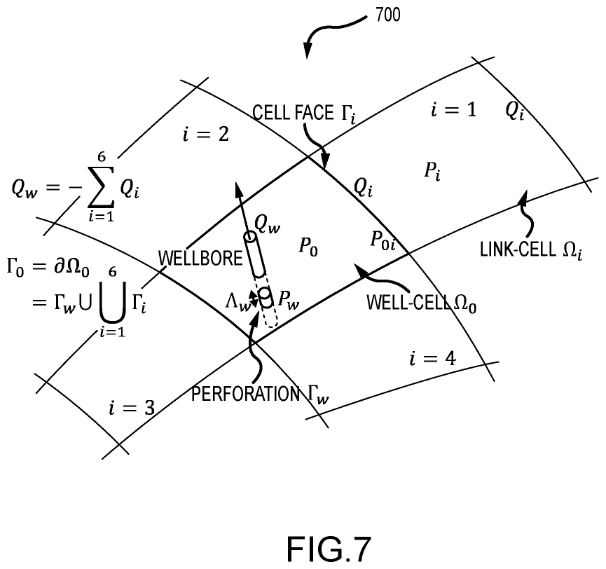

TABLE 1
List of Symbols

| | |
|---|---|
| aᵢ*ᵢ, aⱼ*ⱼ | direction cosines, see Eq. (3) |
| Aᵢ | area of (link-cell or BE) face i, see Eq. (16) |
| [symbol] | set of active link-cell indices, see Eq. (31) |
| c_{c} | contact coefficient of point x′, see Eq. (22) |
| c_{K}, c_{Q} | unit conversion factors, see Eqs. (2) and (26) |
| c_{w}, cᵢ | coefficients relating q to Q on Γ_{w} and Γᵢ, resp., |
| | see Eqs. (18) and (26) |
| C_{w}, Cᵢ | multi-point well-to-cell coupling coefficients, see Eq. (8) |
| d | distance of point x′ from the plane of boundary Γᵢ, |
| | see Eq. (15) |
| [symbol] ᵢ | set of BE indices belonging to link-cell face i, see Eq. (30) |
| f | shape function of q-distribution over Γᵢ, |
| | see Eqs.(18) and (26) |
| F | gradient/flux of G (corresponding to q), |
| | see Eqs. (12) and (15) |
| F | normal component of F on Γ₀ or Γᵢ, see Eqs. (13) and (15) |
| G | free-space Green's function (corresponding to p), |
| | see Eqs. (11) and (15) |
| i | index of cell i = 0, . . . , N or boundary element i = 1, . . . , |
| | n ≥ N |
| I_{w}, Iᵢ | integrals over Γ_{w} and Γᵢ, resp., as defined in Eq. (24) |
| [symbol] | set of inactive link-cell indices, see Eq. (31) |
| I, J, K | grid cell indices |
| J | Jacobian of coordinates mapping x [symbol] χ on Γᵢ, see Eq. (28) |
| k | rock permeability (tensor), see Eq. (2) |
| K | hydraulic conductivity (tensor), see Eq. (1) |
| L_{w} | total length of all perforation segments Λ_{w}, see Eq. (16) |
| Mᵢ | inter-cell transmissibility multiplier associated with Tᵢ, |
| | see Eq. (6) |
| n | total number of boundary elements |
| N | total number of link-cells |
| \hat{n} | outward normal (unit vector) to Γ₀ or Γᵢ, see Eq. (13) |
| [symbol] | numbers of active and inactive link-cells, resp., see Eq. (32) |
| p | fluid pressure, see Eq. (1) |
| P₀ | pressure in well-cell, see Eq. (6) |
| Pᵢ | pressure in link-cell i, see Eq. (6) |
| P₀ᵢ | pressure on (well-cell Ω₀ side of) face Γᵢ, see Eq. (18) |
| P_{w} | wellbore pressure at Γ_{w}, see Eq. (7) |
| q | macroscopic fluid velocity (vector), see Eq. (1) |
| q | normal component of q on Γₒ or Γᵢ, see Eq. (13) |
| Qᵢ | (volumetric) fluid flowrate between well-cell and link-cell i, |
| | see Eq. (6) |
| Q_{w} | total (volumetric) rate of fluid flowing through well, |
| | see Eq. (7) |
| r | Euclidean distance between points x′ and x, see Eq. (14) |
| r_{w} | wellbore radius, see Eq. (16) |
| S | well “skin” factor in well-cell |
| t | time |
| Tᵢ | transmissibility between well-cell and link-cell i, see Eq. (6) |
| T_{0, 0i}, T_{0i, i} | half-cell transmissibilities of well-cell and link-cell i, |
| | see Eq. (20) |
| T_{w} | well connection transmissibility factor, see Eq. (7) |
| \tilde{V}ᵢ | pore volume of cell i, see Eq. (31) |
| x | point in 3D space: x = (x, y, z) |
| x′ | source (or singular) point |
| x_{Λ-}, x_{Λ+} | lower and upper limit of well perforation segment from Λ_{w}, |
| | see Eq. (25) |
| x, y, z | Cartesian coordinates |
| γ, ω, λ | variables of integration domains Γ, Ω and Λ, |
| | see e.g. Eqs. (21) and (24) |
| Γ₀ | boundary of domain Ω₀, see Eq. (16) |
| Γᵢ | inner or outer face of link-cell (or boundary element) i, |
| | see FIG. 7 |
| Γ_{w} | well perforations in well-cell, see FIG. 7 |
| Γ₀ᵢ | face (or boundary element) between well-cell and link-cell i, |
| | see Eq. (18) |
| Γ_{i∞} | face (or boundary element) between link-cell i and infinite |
| | outer domain |
| δ | Dirac's delta function, see Eq. (11) |
| ε_{V}, ε_{T} | (cell activity) thresholds for \tilde{V}ᵢ and Tᵢ, resp., see Eq. (31) |
| Λ_{w} | well perforation segments in well-cell, |
| | see FIG. 7 and Eq. (16) |
| μ | dynamic fluid viscosity, see Eq. (2) |
| σ | fluid sources or sinks in Ω₀, see Eq. (9) |
| χₖ, ψₖ | k^{th} pair of Gaussian quadrature abscissa and weight, resp., |
| | see Eq. (25) |
| Ω₀ | well-cell domain (of local boundary value problem), |
| | see FIG. 7 and Eq. (9) |
| Ωᵢ | domain of link-cell i, see FIG. 7 and Eq. (18) |
| Ω_{∞} | infinite outer domain, see Eq. (18) |

The modeling module 102 may be configured to execute method steps, for instance, steps in a setup method, steps in a method to setup boundary elements, steps in evaluation of a FSWC reservoir model, and/or evaluation of a FSWC well-to-cell coupling model.

The modeling module 102 may be configured to make determinations for at least one of the well-cells 202 and corresponding link-cells 204 in the grid. The modeling module 102 may conduct any combination of the method steps for setup and evaluation for FSWC on one, any combination, or all of the well-cells 202 in a grid or portion of a grid. For instance, for each well-cell 202, the modeling module 102 may execute one or more of the described setup and/or evaluation method steps.

An embodiment of a FSWC procedural setup procedure may include one or more of the modeling module 102 determining if the well-cell is active, initializing global parameters, and setting up a boundary equation model. The setup method steps may further include optional steps, for instance optionally identifying active and inactive link-cells 204, optionally changing K to a diagonal tensor, optionally changing K to a scalar, optionally calculating the perforation segment lengths, optionally splitting the segment into more segments and/or optionally splitting a boundary element into more boundary elements (and incrementing n, accordingly).

An embodiment of a FSWC cell geometry setup may include steps of the modeling module 102 optionally calculating the perforation segment lengths, optionally splitting the segment into more segments, and/or optionally splitting a boundary element into more boundary elements (and incrementing n, accordingly). This step may also be incorporated into either setup methods or evaluation methods or a hybrid of both.

An embodiment of a FSWC system of equation generation procedure may include one or more of the modeling module 102 evaluating, boundary integrals that may be determined analytically, evaluating boundary integrals that require numerical analysis, establishing a system of equations matrix A, incorporating an outer “infinite reservoir” BC to matrix A, looping over boundary elements of active link-cells 204, optionally looping, over boundary elements of inactive ( [symbol] ) link-cells 204.

An embodiment of a FSWC evaluation procedure may include steps of the modeling module 102 resolving the system of equations represented by matrix A, determining the well-cell pressure P₀, determining values representing FSWC model parameters, optionally adjusting corresponding A matrix terms by a Tᵢ-weighted flow difference, optionally incorporating, Pⱼ and Qⱼ contributions from all boundary elements j ∈ [symbol] ᵢ into [symbol] corresponding quantities Pᵢ and Qᵢ of each active link-cell i ∈ [symbol] according to Eq. (30), optionally identifying inter-cell transmissibility multipliers of faces shared by more than one well-cell 202.

Reporting all T_{w} and Mᵢ values back to the parent process may be a final step in which determined parameters are transmitted to a parent process.

A step of optionally incorporating, by the modeling module 102, Pⱼ and Qⱼ contributions from all boundary elements j ∈ [symbol] ᵢ into [symbol] corresponding quantities Pᵢ and Qᵢ of each active link-cell i ∈ [symbol] according to Eq. (30) may only be necessary if n>N. A step of optionally adjusting, by the modeling module 102, corresponding A matrix terms by the Tᵢ-weighted flow difference may only be necessary if there is an imbalance between −Q_{w} and ΣᵢQᵢ (thereby violating Eq. (17)) (the subsequently repeating the step of resolving the linear algebraic equations if initially violative of Eq. (17)). Optional evaluation steps may include steps of the modeling module 102 optionally looping over boundary elements j ∈ [symbol] ᵢ of each inactive link-cell 204, and adding their Neumann type (no flow) BC to matrix A, and the modeling module 102 identifying inter-cell transmissibility multipliers that have been jointly adjusted from two different well-cells and merging their values in terms of their average (of prescribed type).

Looping the FSWC methods over all grid cells (or well-cells 202) and evaluating at each well-cell 202 may be conducted by the modeling module 102. All of the method steps except for the identifying and jointly adjusting inter-cell transmissibility multipliers of adjacent cells may be done for each well-cell 202 and its respective link-cells 204. The implementation of the looping can be done in a number of ways and in any number of orders, and embodiments taught are intended to be exemplary.

Determining, by the modeling module 102, whether a well-cell 202 is active is a determination of whether the well-cell 202 should be modeled as actively contributing to flow characteristics.

Inputting, by the modeling module 102, of relevant data and checking, by the modeling module 102 if the well-cell is active is using existing data to determine whether a well-cell is active. This determination may be based on well data, for instance, the name of the well, tubing radius r_{w}, and trajectory (co-defining Λ_{w}). The well-cell parameters that might be factors include the I, J, K coordinates of the cells, corner points (defining Γᵢ), permeability tensor K, and pore volume \tilde{V}₀. The link-cell 204 parameters considered may include location of centers, transmissibilities Tᵢ, and pore volumes \tilde{V}ᵢ. The perforation parameters may include segment limits (co-defining Λ_{w}) and, potentially, a well “skin” factor S. Optional features that may vary between embodiments of this step may include the unit systems used, the threshold and tolerances set, shape function(s), and the like. If the well-cell 202 is inactive (e.g., \tilde{V}₀<ε_{V}), the modeling module 102 may continue by looping to the next well-cell 202 for determination of well factors (and, optionally, inter-cell transmissibility multipliers). It can be appreciated that the methods herein disclosed may be conducted in a number of different ways and require different inputs and data processing. This step is merely an embodiment, and other inputs and methods for determining whether a well-cell 202 is active are contemplated. It should be noted that many of these data may be or may be derived from measured data. For instance, samples can be taken to determine measurable data inputs for the reservoir simulator and/or the FSWC model. In this way, the FSWC model may represent actual physical data, such that the reservoir simulator and/or FSWC account for the behavior of a real reservoir and predict physical relationships between parameters in the reservoir. Examples of these measurable values may include porosity, seismic data, and/or the like. For instance, the FSWC model may receive at least one input that represents a physical measurement in the reservoir being simulated. In an embodiment, the reservoir simulator may receive at least one input that represents a physical measurement in the reservoir being simulated. The determined T_{w} and Mᵢs may also be derived from data that was physically measured in a reservoir area. Further, the determined T_{w} and Mᵢs may also represent physical relationships between the physical volumes in the physical reservoir being simulated, the physical volumes represented as cells in a grid (e.g. the well-cell 202 and its corresponding link-cells 204).

Optionally, identifying, by the modeling module 102, active ( [symbol] ) and inactive ( [symbol] ) link-cells 204 is a step in which active ( [symbol] ) link-cells 204 are distinguished from inactive ( [symbol] ) link-cells 204. This may allow for the model to apply a simplifying assumption that there is no flow through the inactive ( [symbol] ) link-cells 204. The determining, by the modeling module 102, whether link-cells 204 are active ( [symbol] ) may be done according to criteria in Eq. (31). In an embodiment where all link-cells are inactive (i.e., [symbol] =0), zero flow may be assumed in the well-cell 202, and the modeling module 102 may continue to evaluate the next well-cell 202 in a grid. In an alternative embodiment, instead of distinguishing between active ( [symbol] ) and inactive ( [symbol] ) link-cells 204, the inactive ( [symbol] ) link-cells 204 may be modeled as active ( [symbol] ) link-cells 204 with low to no transmissibility.

Initializing, by the modeling module 102, global parameters is a step in which the global parameters to solve the systems of equations are provided. These global parameters may include, for instance, unit conversion factors c_{K} and c_{Q}, fluid viscosity (e.g. μ=1 cP where its value does not affect T_{w} or Mᵢ), and/or wellbore pressure P_{w} (for instance P_{w}=1,000 bar, where its value does not affect T_{w} or Mᵢ). The mentioned global parameters are merely exemplary, and any number of other parameters may be used as global parameters to evaluate the FSWC model are contemplated.

Optionally changing, by the modeling module 102, K to a diagonal tensor is a step of changing K to a diagonal tensor. The modeling module 102 may accomplish this by applying mapping of Eq. (3) to all spatial coordinates, volumes and transmissibilities. In an embodiment, the modeling module 102 may determine that K is already substantially diagonal and need not be changed and may decide not to change K.

Optionally changing, by the modeling module 102, K to a scalar is step of changing K to a scalar. The modeling module 102 may accomplish this by applying mapping of Eq. (5) to all spatial coordinates, volumes, and transmissibilities. In an embodiment, the modeling module 102 may determine that K is sufficiently scalar such that no change is necessary and may decide to not change K.

Optionally calculating, by the modeling module 102, the perforation segment lengths and their total length L_{w}=|Λ_{w}| is a step where the perforation lengths and total length L_{w}=|Λ_{w}| are calculated. In an embodiment, the perforation lengths could come from the preprocessor.

Optionally splitting, by the modeling module 102, the perforation segment into more segments is a step in which well perforation segments that cross from one well-cell 202 to another are better characterized as segments of the perforation lengths being located in each cell. The splitting may be done if the modeling module 102 determines that perforation segment length relative to the well-cell 202 size, exceeds a prescribed tolerance. For example, the segmenting may be accomplished by determining whether a ratio of a bounding box around a perforation (or existing perforation segment for further segmentation) to the bounding box of the enclosing well-cell 202 exceeds a threshold. Examples of this threshold may include a ratio of 0.2. In another embodiment, the ratio may be in a range of 0.05 to 0.5. In an embodiment, determining whether segment length relative to the well-cell 202 size, exceeds a prescribed tolerance determining may include determining whether the maximum dimension (max(b_{w}/b_{c})) of a ratio of well perforation (segment) bounding box (b_{w}) to a well-cell (202) bounding box (b_{c}) exceeds a predetermined ratio threshold.

Initializing n=N and constructing n boundary elements, by the modeling module 102, from the input link-cell faces Γ_{i=1, . . . ,N}, is setting up boundary elements for FSWC determinations. This creates a baseline where the boundary elements considered are merely the faces shared by the well-cell 202 and its link-cells 204.

Optionally splitting, by the modeling module 102, a boundary element into more boundary elements is increasing resolution of the model by splitting faces into subfaces with separate analyses. For each additional boundary element determined, the modeling module may increment n, accordingly. The modeling module 102 may accomplish this by finding the shortest distance d_{iw} of each cell face Γᵢ from well perforations Λ_{w} relative to the face size and, determining whether d_{iw} is smaller than a predetermined threshold. In an embodiment, the shortest distance d_{iw} may be determined from any point on the relevant boundary element, for instance, the center of the relevant boundary element or the nearest point of the boundary element to the well-perforation (or segment). The shortest distance, d_{iw} may be determined from any point in a well perforation (or segment), for instance, the point of the well perforation nearest the point on the boundary element from which the shortest distance, d_{iw} is computed or the point that represents a middle or center of the well perforation (or segment). One way of accomplishing this comparison is to determine whether the ratio of d_{iw} to the square root of the area of a boundary element is below a particular predetermined ratio threshold. A relatively equivalent and perhaps more computationally efficient manner to conduct the comparison is to determine whether the ratio of the square of the minimum distance (d_{iw}²) to the area of the relevant boundary element or face is smaller than a predetermined ratio threshold. In different embodiments, this ratio threshold may be 0.1, 0.2, 0.3, 0.4, 0.5, 0.6, 0.7, or in a range of 0.1 to 0.7 (note that the square root of 0.2 is about 0.45 and the square root of 0.4 is about 0.63 for cases where the square root relationship is used). If d_{iw} is smaller than a predetermined threshold, the modeling module 102 may split the boundary element into more boundary elements and increment n accordingly.

Evaluating, by the modeling module 102, integrals that may be determined analytically is evaluating integrals that do not require numerical evaluation. In an embodiment, integral I_{ww}=∫_{Λ}_{_{w}}I_{w}dλ in Eq. (24) is a step where an integral is evaluated analytically (with two analytical integral evaluations). This step may be conducted using the effective wellbore radius and may further account for the skin factor S, where r̅_{w}=r_{w}e^{-S}. In an embodiment, any integral evaluations over the well domain (often denoted with subscript w) may be conducted analytically. In an embodiment, the established Eq. (24) may represent an “inner BC” that uses the first two lines in Eq. (18) and involves well perforations (P_{w}, Q_{w}) and boundary elements on the well-cell (Ω₀) side (P₀ᵢ, Qᵢ).

Evaluating, by the modeling module 102, integrals that require numerical analysis is evaluating integrals that cannot be resolved analytically. In an embodiment, integrals I_{wi}=∫_{Λ}_{_{w}}IᵢdΛ in Eq. (24), coefficients cᵢ in Eq. (26), and integrals Iₑᵢ=∫_{Γ}_{ₑ}Iᵢdγ in Eq. (27) are evaluations that require numerical solutions. It should be recognized that the double-integrals I_{ww} over the well domains may be determined analytically, but integrals in this step may require both the analytical evaluation over the domain of point x and numerical evaluation over the domain of point x′. Determining, by the modeling module 102, I_{wi}, may have no closed-form expression and may, consequently, need to be approximated numerically. Numerical approximation methods include, for instance, Gaussian quadrature (hereinafter, “GQ”). In an embodiment, this evaluating step may be further subdivided into sub-steps to be executed by the modeling module 102. For instance, sub-steps may include looping over cell faces i=1, . . . , n and forming their polygons Γᵢ with ordered vertices in three dimensions, looping over perforation segments in Λ_{w} for integrals I_{wi}, looping over boundary elements e=1, . . . , n for integrals Iₑᵢ, looping over Gaussian quadrature points (e.g. {χₖ, ψₖ}) and forming source points x′=x_{Λ-}+χₖ (x_{Λ+}−x_{Λ-}) for integrals I_{wi}, looping over double Gaussian quadrature points (e.g. {χₖ, ψₖ} and {χₗ, ψₗ}) and forming source points x′ [symbol] ₑ χ, splitting each polygon Γᵢ into triangles Δᵢⱼ with x′ in one of their vertices for each point x′, transforming Cartesian coordinates of each triangle's vertices into two-dimensional polar coordinates, and evaluating integrals Iᵢ and coefficients cᵢ over Δᵢⱼ (i.e. the triangles) and further over Γᵢ (the polygon faces) and then further over Λ_{w} or Γₑ (for Iᵢ and cᵢ respectively). In other words, numerical analysis of these integrals may include integrating over the triangles, then summing those integrals to give integrals over the polygons (BEs), and then summing all those to give the GQ sums of the outer integrals over Λ_{w} or Γₑ.

Populating, by the modeling module 102, matrix A is setting up a matrix to solve a system of equations. In an embodiment, the populating may entail populating an m×m matrix A (where m=3n+1) with n+1 rows of sets I_{ww}, I_{wi}, Iₑᵢ multiplying the “inner BCs”, and m-sized vector B with the corresponding P_{w} terms.

Adding, by the modeling module, an outer “infinite reservoir” BEM Eq. (29) to matrix A, for each “outer” boundary element (face Γᵢ at Ω_{∞}, i=1, . . . , n), is adding to matrix A n rows of sets I_{wi}, Iₑᵢ multiplying the “outer BCs”.

Looping, by the modeling module 102, over boundary elements j ∈ [symbol] ᵢ of each active link-cell 204, and adding, by the modeling module 102, their Robin type (mixed) BC Eq. (19) to matrix A represents adding the relationships of fluid flow through active link-cells 204 to the system of equations. In an embodiment, this step may contribute n [symbol] (representing the number of active [symbol] boundary elements) BCs that may be considered “link BCs.” In an embodiment, no distinction is made between active [symbol] and inactive [symbol] link-cells 204, the inactive [symbol] links cells perhaps evaluated as active [symbol] link-cells 204 with low to no transmissibilities.

Optionally, looping, by the modeling module 102, over boundary elements j ∈ [symbol] ᵢ of each inactive [symbol] link-cell 204, and adding, by the modeling module 102, their Neumann type BC Qᵢ=0 to matrix A is adding the relationships of no fluid flow through inactive link-cells 204 to the system of equations. In an embodiment, this step may contribute [symbol] (representing the number of inactive [symbol] boundary elements) BCs that may be considered “link BCs.” This step may be unnecessary in embodiments in which the inactive [symbol] link-cells 204 are treated like active [symbol] link-cells 204, perhaps with low to no transmissibilities.

Resolving, by the modeling module 102, the system of equations is solving the system to understand fluid behavior in the grid cells. In an embodiment, the system of equations may be a linear system of algebraic equations. For instance, the system of equations may be modeled as a matrix operation, A·X=B for the unknown vector X consisting of Q_{w}, P₀ᵢ, Qᵢ and Pᵢ, where i refers to boundary elements i=1, . . . , n.

Determining, by the modeling module 102 the well-cell pressure P₀ is determining a well-cell pressure based on the resolved system of equations. The well-cell pressure P₀ may be determined by using a root-search algorithm to find roots of Eq. (33) with respect to P₀. Examples of root-search algorithms may include the Newton method, as taught in this specification. In other embodiments, different root-search algorithms may be used.

Determining, by the modeling module 102, values of T_{w} is determining the well connection transmissibility factor. The modeling module 102 can use Eq. (7) to determine the well connection transmissibility factor T_{w}. The modeling module 102 can further, optionally, determine inter-cell transmissibility multipliers M_{i=1, . . . ,N} using Eq. (6) as well.

Optionally adjusting, by the modeling module 102, corresponding A matrix terms by the Tᵢ-weighted difference if there is an imbalance between −Q_{w} and ΣᵢQᵢ (thereby violating Eq. (17)) is adjusting elements of the A matrix to conform to a material balance with respect to flow in the well-cell 202 and its corresponding link-cells 204. In an embodiment, the Tᵢ-weighted flow difference may be described by the following Eq. (34)

$${T}_{i} - weighted difference = \frac{{T}_{i} ( {Q}_{w} + {\sum }_{j} {Q}_{j} )}{{\sum }_{j} {T}_{j}} \qquad ( 34 )$$

The modeling module may repeat the step of resolving the linear algebraic equations if Eq. (17) is initially violated. Alternatively, the Q_{w} term may be eliminated from A, B and X by including Eq. (17) directly in the step in which vectors A and B are formed (e.g. the populating, by the modeling module 102, an m×m matrix A with n+1 rows of sets I_{ww}, I_{wi}, Iₑᵢ, and m-sized vector B with the corresponding P_{w} terms).

Optionally incorporating, by the modeling module 102, Pⱼ and Qⱼ contributions from all boundary elements j ∈ [symbol] ᵢ into [symbol] corresponding quantities Pᵢ and Qᵢ of each active link-cell i ∈ [symbol] according to Eq. (30). The modeling module 102 may determine such incorporating is necessary if n>N, and the modeling module 102 may determine the incorporating is unnecessary if n=N.

Optionally identifying, by the modeling module 102, inter-cell transmissibility multipliers that have been jointly adjusted from two different well-cells and merging their values in terms of their average (of prescribed type) is a step in which adjacent well-cells 202 need to resolve which inter-cell transmissibility multiplier to use between the cells. In an embodiment, two well-cells 202 may be adjacent to one another. After looping over all of the well-cells 202 for FSWC evaluation, the at least one common face of the adjacent well-cells 202 will have two inter-cell transmissibility multipliers, one for each of the independent well-cell 202 FSWC determinations. The common face can only have one inter-cell transmissibility multiplier in the final model, so the values for the inter-cell transmissibility multipliers of the common face may need to be reconciled. One method to do this is to average the inter-cell transmissibility multiplier values. The average may use uniform weighting or the average may be weighted based on certain properties, for instance, cell pore volume. In an alternative embodiment, the simulator that will receive the values from the FSWC model can reconcile the inter-cell transmissibility multipliers of common faces by treating the cells separately, such that this method step is unnecessary.

Reporting, by the modeling module 102, all values back to the parent process is reporting the values used to describe the nature of each well-cell 202 and/or its local cell array to some parent process. These reported values may include, for instance, one or more of T_{w} and one or more Mᵢs. In an embodiment, only T_{w} values are reported. In an embodiment, each of the well-cells 202 evaluated is assigned a T_{w} and at least one Mᵢ. The parent process may be, for instance, a serial or parallel reservoir simulation run, preprocessing software (RMS) run, Cloud microservice, and/or the like. The reservoir simulator may use the one or more of T_{w} and one or more Mᵢs transmitted in a simulation of a reservoir. The reservoir simulator may use one or more of T_{w} and one or more Mᵢs that represent physical parameters, perhaps based on physical and/or measured inputs, to output a simulation of an existing physical reservoir.

FIG. 7 shows a detailed rendition 700 of an embodiment of a system portion 200 of an FVM grid with a well-cell 202 surrounded by link-cells 204 of FIG. 2. FIG. 7 represents a more detailed representation of the embodiment of FIG. 2 with relevant explanations of LBVP quantities and relationships between relevant quantities. FIG. 7 relies on using the symbols as described in Table 1, rather than the numbering shown in and described with respect to FIG. 2.

### Flowcharts

FIGS. 8-14 show flowcharts of embodiments of methods for the setting up of and implementing FSWC. The methods disclosed in the flowcharts are non-exhaustive and merely demonstrate potential embodiments of steps and orders. The methods of FIGS. 8-14 must be construed in the context of the entire specification, including elements taught in descriptions of FIGS. 1-7, for instance, the computer system 100, the modeling module 102, response module 104, and/or the like taught in FIGS. 1-7.

FIG. 8 shows a flowchart of an embodiment of a method 800 for generating an FSWC model. The modeling module 102 and/or the response module 104 may be the modeling module 102 and/or the response module 104 taught in the descriptions of FIGS. 1-7, although any suitable modeling module 102 and/or the response module 104 may be employed in alternative embodiments. All methods for accomplishing the steps of the flowcharts disclosed in this specification are contemplated, including all of the capabilities of the computer system 100, the equations presented, the variables presented and described, and the modules of the computer system 100.

Step 802 is conducting, by the modeling module 102, a FSWC procedural setup procedure. An embodiment of the FSWC procedural setup procedure may include any steps represented as procedural setup steps in this specification. An embodiment of procedural setup steps may include one or more of the modeling module 102 inputting all relevant data and checking if the well-cell is active, initializing global parameters, and initializing and constructing n boundary elements. The setup method steps may further include optional steps, for instance optionally identifying active and inactive link-cells 204, optionally changing K to a diagonal tensor, optionally changing K to a scalar, optionally calculating the perforation segment lengths, optionally splitting the segment into more segments and/or optionally splitting a boundary element into more boundary elements (and increment n, accordingly).

Step 804 is optionally, conducting, by the modeling module 102, a FSWC cell geometry setup procedure. An embodiment of the FSWC cell geometry setup procedure may include any steps represented as geometry setup procedure steps in this specification. An embodiment of the FSWC cell geometry setup procedure may include steps of the modeling module 102 optionally calculating the perforation segment lengths, optionally splitting the segment into more segments, and/or optionally splitting a boundary element into more boundary elements (and incrementing n, accordingly). This step 804 may also be incorporated into either procedural setup methods (Step 802) or evaluation methods (Step 806) or a hybrid of both (with some steps incorporated into step 802 and others into step 806).

Step 806 is conducting, by the modeling module 102, a FSWC system of equation generation procedure. An embodiment of a FSWC system of equation generation procedure may include one or more of the modeling module 102 evaluating, boundary condition integrals that may be determined analytically, evaluating boundary condition integrals that require numerical analysis, establishing a system of equations matrix A, incorporating an outer “infinite reservoir” BC to matrix A, looping over boundary elements of active ( [symbol] ) link-cells 204, optionally looping, over boundary elements of inactive ( [symbol] ) link-cells 204.

Step 808 is conducting, by the modeling module 102, a FSWC evaluation procedure. An embodiment of the FSWC evaluation procedure may include any steps represented as FSWC evaluation procedure steps in this specification. An embodiment of the FSWC evaluation procedures may include steps of the modeling module 102.

Step 810 is reporting, by the modeling module 102 and/or the response module 104, values determined by the FSWC model back to a parent process. These reported values may include, for instance, one or more of a T_{w} and one or more Mᵢs. In an embodiment, only T_{w} values are reported, perhaps for each well-cell 202 and/or for each active ( [symbol] ) well-cell 202. In an embodiment, each of the well-cells 202 evaluated is assigned a T_{w} and at least one Mᵢ. The parent process may be, for instance, a serial or parallel reservoir simulation run, preprocessing software (RMS) run, Cloud microservice, and/or the like.

In an embodiment, each of the steps of the method shown in FIG. 8 is a distinct step. In another embodiment, although depicted as distinct steps in FIG. 8, steps 802-810 may not be distinct steps. In other embodiments, the method shown in FIG. 8 may not have all of the above steps and/or may have other steps in addition to or instead of those listed above. The steps of the method shown in FIG. 8 may be performed in another order. Subsets of the steps listed above as part of the method shown in FIG. 8 may be used to form their own method. The steps of method 800 may be repeated in any combination and order any number of times, for instance, continuously looping in order to cycle through and evaluate the FSWC model for each well-cell 202 in a grid.

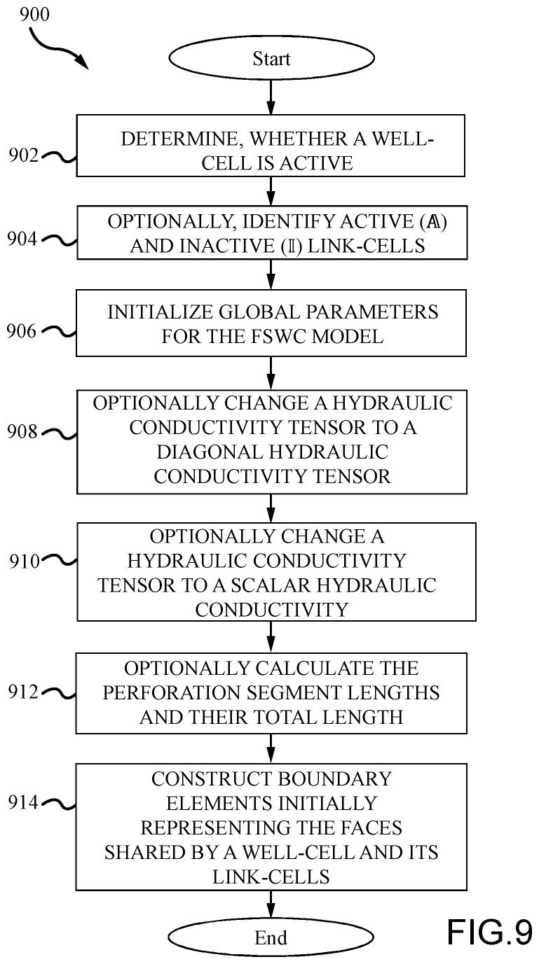

FIG. 9 shows a flowchart of an embodiment of a method 900 for conducting a procedural setup procedure. The method 900 may be an embodiment of the method step 802. The modeling module 102 and/or the response module 104 may be the modeling module 102 and/or the response module 104 taught in any or any combination the descriptions of FIGS. 1-8, although any suitable modeling module 102 and/or the response module 104 may be employed in alternative embodiments. All methods for accomplishing the steps of the flowcharts disclosed in this specification are contemplated, including all of the capabilities of the computer system 100, the equations presented, the variables presented and described, and the modules of the computer system 100.

Step 902 is determining, by the modeling module 102, whether a well-cell 202 is active. This step may include sub-steps of inputting, by the modeling module 102, relevant data and checking, by the modeling module, 102 if the well-cell is active using existing data. This determining step 902 may be conducted in any manner disclosed in the specification.

Step 904 is optionally, identifying, by the modeling module 102, active ( [symbol] ) and inactive ( [symbol] ) link-cells 204, a step in which active ( [symbol] ) link-cells 204 are distinguished from inactive ( [symbol] ) link-cells 204. This optional identifying step 904 may be conducted in any manner disclosed in the specification.

Step 906 is initializing, by the modeling module 102, global parameters, a step in which the global parameters to solve the FSWC systems of equations are provided. This initializing step 906 may be conducted in any manner disclosed in the specification.

Step 908 is optionally changing, by the modeling module 102, a hydraulic conductivity tensor to a diagonal hydraulic conductivity tensor. This changing may be conducted in any manner disclosed in the specification. The modeling module 102 may accomplish this by applying mapping of Eq. (3) to all spatial coordinates, volumes and transmissibilities. In an embodiment, the modeling module 102 may determine that K is already substantially diagonal and need not be changed and may decide not to change K. This optional changing step 908 may be conducted in any manner disclosed in the specification.

Step 910 is optionally changing, by the modeling module 102, a hydraulic conductivity tensor to a scalar hydraulic conductivity. The modeling module 102 may accomplish this by applying mapping of Eq. (5) to all spatial coordinates, volumes, and transmissibilities. In an embodiment, the modeling module 102 may determine that K is sufficiently scalar such that no change is necessary and may decide to not change K.

This optional changing step 910 may be conducted in any manner disclosed in the specification.

Step 912 is optionally calculating, by the modeling module 102, the perforation segment lengths and their total length L_{w}=|Λ_{w}|. In an embodiment, the perforation lengths could come from the preprocessor. This optional calculating step 912 may be conducted in any manner disclosed in the specification.

Step 914 is constructing, by the modeling module 102, boundary elements initially representing the faces shared by a well-cell 202 and its link-cells 204. This step 914 may include initializing n=N and constructing n boundary elements, by the modeling module 102, from the input link-cell faces Γ_{i=1, . . . ,N}, setting up boundary elements for FSWC determinations. This creates a baseline where the boundary elements considered are merely the faces shared by the well-cell 202 and its link-cells 204. These may later be split into more boundary elements if it is determined to be appropriate based on the methods of this specification (potentially, while incrementing n accordingly). This initializing step 914 may be conducted in any manner disclosed in the specification.

In an embodiment, each of the steps of the method shown in FIG. 9 is a distinct step. In another embodiment, although depicted as distinct steps in FIG. 9, steps 902-914 may not be distinct steps. In other embodiments, the method shown in FIG. 9 may not have all of the above steps and/or may have other steps in addition to or instead of those listed above. The steps of the method shown in FIG. 9 may be performed in another order. Subsets of the steps listed above as part of the method shown in FIG. 9 may be used to form their own method. The steps of method 900 may be repeated in any combination and order any number of times, for instance, continuously looping in order to cycle through and evaluate the FSWC model for each well-cell 202 in a grid.

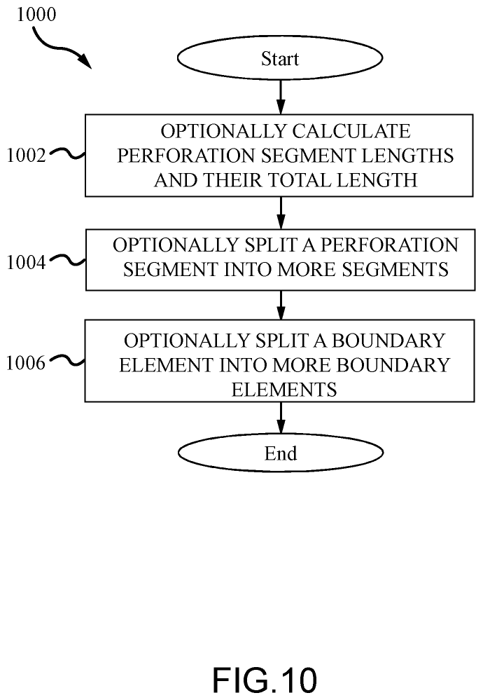

FIG. 10 shows a flowchart of an embodiment of a method 1000 for conducting a FSWC cell geometry setup procedure. The method 1000 may be an embodiment of step 804. The modeling module 102 and/or the response module 104 may be the modeling module 102 and/or the response module 104 taught in any or any combination of the descriptions of FIGS. 1-8, although any suitable modeling module 102 and/or the response module 104 may be employed in alternative embodiments. All methods for accomplishing the steps of the flowcharts disclosed in this specification are contemplated, including all of the capabilities of the computer system 100, the equations presented, the variables presented and described, and the modules of the computer system 100.

Step 1002 is optionally calculating, by the modeling module 102, the perforation segment lengths and their total length L_{w}=|Λ_{w}|. In an embodiment, the perforation lengths could come from the preprocessor. Step 1002 may be an embodiment of optional step 912. This optional calculating step 1002 may be conducted in any manner disclosed in the specification.

Step 1004 is optionally splitting, by the modeling module 102, a perforation segment into more segments, a step in which well perforations are better characterized as sub-segments of the perforations segments. This optional splitting into segment step 1004 may be conducted in any manner disclosed in this specification.

Step 1006 is optionally splitting, by the modeling module 102, a boundary element into more boundary elements. This step 1006 may increase resolution of the model by splitting faces into subfaces with separate analyses. This optional splitting step 1006 may be conducted in any manner disclosed in this specification.

In an embodiment, each of the steps of the method shown in FIG. 10 is a distinct step. In another embodiment, although depicted as distinct steps in FIG. 10, steps 1002-1006 may not be distinct steps. In other embodiments, the method shown in FIG. 10 may not have all of the above steps and/or may have other steps in addition to or instead of those listed above. The steps of the method shown in FIG. 10 may be performed in another order. Subsets of the steps listed above as part of the method shown in FIG. 10 may be used to form their own method. The steps of method 1000 may be repeated in any combination and order any number of times, for instance, continuously looping in order to cycle through and evaluate the FSWC model for each well-cell 202 in a grid.

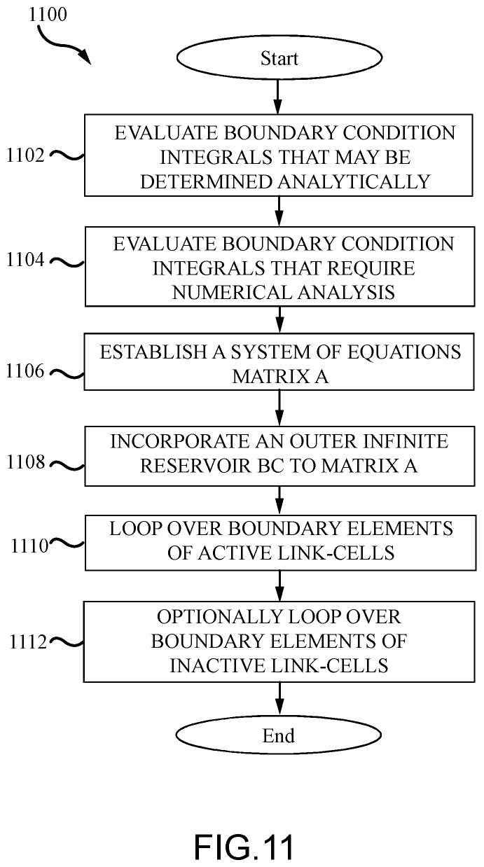

FIG. 11 shows a flowchart of an embodiment of a method 1100 for conducting a FSWC system of equations generating procedure. The method 1100 may be an embodiment of step 806. The modeling module 102 and/or the response module 104 may be the modeling module 102 and/or the response module 104 taught in any or any combination of the descriptions of FIGS. 1-8, although any suitable modeling module 102 and/or the response module 104 may be employed in alternative embodiments. All methods for accomplishing the steps of the flowcharts disclosed in this specification are contemplated, including all of the capabilities of the computer system 100, the equations presented, the variables presented and described, and the modules of the computer system 100.

Step 1102 is evaluating, by the modeling module 102, boundary condition integrals that may be determined analytically (i.e. evaluating integrals that do not require numerical evaluation). In an embodiment, integral I_{ww}=∫_{Λ}_{_{w}}I_{w}dλ in Eq. (24) may be integrated analytically (with two analytical integral evaluations). This step may be conducted using the effective wellbore radius and may further account for the skin factor S, where r̅_{w}=r_{w}e^{-S}. In an embodiment, any integral evaluations over the well domain (often denoted with subscript w) may be conducted analytically. In an embodiment, the established Eq. (24) may represent an “inner BC” that uses the first two lines in Eq. (18) and involves well perforations (P_{w}, Q_{w}) and boundary elements on the well-cell (Ω₀) side (P₀ᵢ, Qᵢ). This evaluating step 1102 may be conducted in any manner disclosed in this specification.

Step 1104 is evaluating, by the modeling module 102, boundary condition integrals that require numerical analysis. This step 1104 may involve evaluating integrals that cannot be resolved analytically without numerical analysis. In an embodiment, integrals I_{wi}=∫_{Λ}_{_{w}}Iᵢdλ in Eq. (24), coefficients cᵢ in Eq. (26), and integrals Iₑᵢ=∫_{Γ}_{ₑ}Iᵢdγ in Eq. (27) are evaluations that require numerical solutions. It should be recognized that the double-integrals I_{ww} over the well domains may be determined analytically, but integrals in this step may require both the analytical evaluation over the domain of point x and numerical evaluation over the domain of point x′. Determining, by the modeling module 102, I_{wi}, may have no closed form expression and may, consequently, need to be approximated numerically. Numerical approximation methods include, for instance, Gaussian quadrature (hereinafter, “GQ”). In an embodiment, this evaluating step may be further subdivided into sub-steps to be executed by the modeling module 102. For instance, sub-steps may include looping over cell faces i=1, . . . , n and forming their polygons Γᵢ with ordered vertices in three dimensions, looping over perforation segments in Λ_{w} for integrals I_{wi}, looping over boundary elements e=1, . . . , n for integrals Iₑᵢ, looping over Gaussian quadrature points (e.g. {χₖ, ψₖ}) and forming source points x′=x_{Λ-}+χₖ (x_{Λ+}−x_{Λ-}) for integrals I_{wi}, looping over double Gaussian quadrature points (e.g. {χₖ, ψₖ} and {χₗ, ψₗ}) and forming source points x′ [symbol] ₑχ, splitting each polygon Γᵢ into triangles Δᵢⱼ with x′ in one of their vertices for each point x′, transforming Cartesian coordinates of each triangle's vertices into two-dimensional polar coordinates, and evaluating integrals Iᵢ and coefficients cᵢ over Δᵢⱼ (i.e. the triangles) and further over Γᵢ (the polygon faces) and then further over Λ_{w} or Γₑ (for Iᵢ and cᵢ respectively). In other words, numerical analysis of these integrals may include integrating over the triangles, then summing those integrals to give integrals over the polygons (BEs), and then summing all those to give the GQ sums of the outer integrals over Λ_{w} or Γₑ. This evaluating step 1104 may be conducted in any manner disclosed in this specification.

Step 1106 is establishing, by the modeling module 102, a system of equations matrix A. Matrix A is a matrix to solve a system of equations. In an embodiment, the setting up 1106 may entail populating an m×m matrix A (where m=3n+1) with n+1 rows of sets I_{ww}, I_{wi}, Iₑᵢ multiplying the “inner BCs”, and m-sized vector B with the corresponding P_{w} terms. This establishing step 1106 may be conducted in any manner disclosed in this specification.

Step 1108 is incorporating, by the modeling module 102, an outer “infinite reservoir” BEM Eq. (29) to matrix A, for each “outer” boundary element (face Γᵢ at Ωᵢ, i=1, . . . , n), is adding to matrix A n rows of sets I_{wi}, Iₑᵢ multiplying the “outer BCs”. This incorporating step 1108 may be conducted in any manner disclosed in this specification.

Step 1110 is looping, by the modeling module 102, over boundary elements of active link-cells 204. The looping 110 may be done over boundary elements j ∈ [symbol] ᵢ of each active link-cell 204 and adding, by the modeling module 102, their Robin type (mixed) BC Eq. (19) to matrix A represents adding the relationships of fluid flow through active ( [symbol] ) link-cells 204 to the system of equations. In an embodiment, this step may contribute [symbol] (representing the number of active ( [symbol] ) boundary elements) BCs that may be considered “link BCs.” In an embodiment, no distinction is made between active ( [symbol] ) and inactive ( [symbol] ) link-cells 204, the inactive ( [symbol] ) links cells perhaps evaluated as active ( [symbol] ) link-cells 204 with low to no transmissibilities. This looping step 1110 may be conducted in any manner disclosed in this specification.

Step 1112 is optionally looping, by the modeling module 102, over boundary elements of inactive ( [symbol] ) link-cells 204. This looping 1112 may be done over all boundary elements j ∈ [symbol] ᵢ of each inactive ( [symbol] ) link-cell 204, and adding, by the modeling module 102, their Neumann type BC Qᵢ=0 to matrix A is adding the relationships of no fluid flow through inactive ( [symbol] ) link-cells 204 to the system of equations. In an embodiment, this step may contribute [symbol] (representing the number of inactive ( [symbol] ) boundary elements or faces) BCs that may be considered “link BCs.” This step may be unnecessary in embodiments in which the inactive ( [symbol] ) link-cells 204 are treated like active ( [symbol] ) link-cells 204, perhaps with low to no transmissibilities. This optional looping step 1112 may be conducted in any manner disclosed in this specification.

In an embodiment, each of the steps of the method shown in FIG. 11 is a distinct step. In another embodiment, although depicted as distinct steps in FIG. 11, steps 1102-1112 may not be distinct steps. In other embodiments, the method shown in FIG. 11 may not have all of the above steps and/or may have other steps in addition to or instead of those listed above. The steps of the method shown in FIG. 11 may be performed in another order. Subsets of the steps listed above as part of the method shown in FIG. 11 may be used to form their own method. The steps of method 1100 may be repeated in any combination and order any number of times, for instance, continuously looping in order to cycle through and evaluate the FSWC model for each well-cell 202 in a grid.

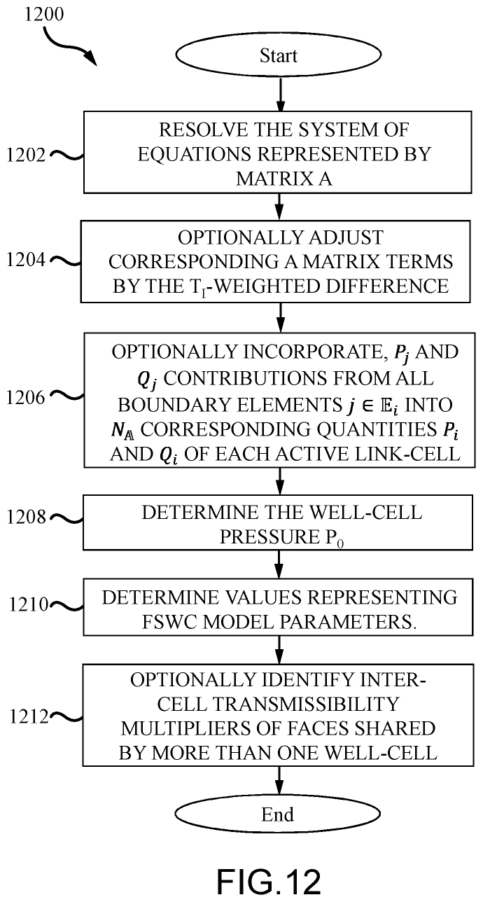

FIG. 12 shows a flowchart of an embodiment of a method 1200 for conducting a FSWC system of equations evaluating procedure. The method 1200 may be an embodiment of step 808. The modeling module 102 and/or the response module 104 may be the modeling module 102 and/or the response module 104 taught in any or any combination of the descriptions of FIGS. 1-8, although any suitable modeling module 102 and/or the response module 104 may be employed in alternative embodiments. All methods for accomplishing the steps of the flowcharts disclosed in this specification are contemplated, including all of the capabilities of the computer system 100, the equations presented, the variables presented and described, and the modules of the computer system 100.

Step 1202 is resolving, by the modeling module 102, the system of equations represented by matrix A. Step 1202 may be solving the system to understand fluid behavior in the grid cells. In an embodiment, the system of equations may be a linear system of algebraic equations. For instance, the system of equations may be modeled as a matrix operation, A·X=B for the unknown vector X consisting of Q_{w}, P₀ᵢ, Qᵢ and Pᵢ, where i refers to boundary elements i=1, . . . , n. This resolving step 1202 may be conducted in any manner disclosed in this specification.

Step 1204 is optionally adjusting, by the modeling module 102, corresponding A matrix terms by the T₁-weighted difference. This step 1208 may be executed if there is an imbalance between −Q_{w}, and ΣᵢQᵢ (thereby violating Eq. (17)). Step 1120 may be accomplished by adjusting elements of the A matrix to conform to a material balance with respect to flow in the well-cell 202 and its corresponding link-cells 204. In an embodiment, the T₁-weighted difference may be described by Eq. (34). The modeling module 102 may repeat the step of resolving the linear algebraic equations if Eq. (17) is initially violated. Alternatively, the Q_{w} term may be eliminated from A, B and X by including Eq. (17) directly in the step in which vectors A and B are formed (e.g. the populating, by the modeling module 102, an m×m matrix A with n+1 rows of sets I_{ww}, I_{wi}, Iₑᵢ, and m-sized vector B with the corresponding P_{w} terms). This optional adjusting step 1208 may be conducted in any manner disclosed in this specification.

Step 1206 is optionally incorporating, by the modeling module 102, Pⱼ and Qⱼ contributions from all boundary elements j ∈ [symbol] ᵢ into [symbol] corresponding quantities Pᵢ and Qᵢ of each active link-cell i ∈ [symbol] according to Eq. (30). The modeling module 102 may determine such incorporating is necessary if n>N, and the modeling module 102 may determine the incorporating is unnecessary if n≤N. This optional incorporating step 1210 may be conducted in any manner disclosed in this specification.

Step 1208 is determining, by the modeling module 102 the well-cell pressure P₀. Step 1204 may be determining a well-cell pressure based on the resolved system of equations. The well-cell pressure P₀ may be determined by using a root-search algorithm to find roots of Eq. (33) with respect to P₀. Examples of root-search algorithms may include the Newton method, as taught in this specification. In other embodiments, different root-search algorithms may be used. This determining step 1204 may be conducted in any manner disclosed in this specification.

Step 1210 is determining, by the modeling module 102, values representing FSWC model parameters. In this step 1206, the well connection transmissibility factor T_{w} is determined. The modeling module 102 can use Eq. (7) to determine the well connection transmissibility factor T_{w}. The modeling module 102 can further, optionally, determine inter-cell transmissibility multipliers M_{i=1, . . . ,N} using Eq. (6) as well. This determining step 1206 may be conducted in any manner disclosed in this specification.

Step 1212 is optionally identifying, by the modeling module 102, inter-cell transmissibility multipliers of faces shared by more than one well-cell 202. In an embodiment, inter-cell transmissibility multipliers that have been jointly adjusted from two different well-cells may have their values merged in terms of their average (of prescribed type). Step 1212 is a step in which adjacent well-cells 202 need to resolve which inter-cell transmissibility multiplier to use between the cells. In an embodiment, two well-cells 202 may be adjacent to one another. After looping over all of the well-cells 202 for FSWC evaluation, the at least one common face of the adjacent well-cells 202 will have two inter-cell transmissibility multipliers, one for each of the independent well-cell 202 FSWC determinations. The common face can only have one inter-cell transmissibility multiplier in the final model, so the values for the inter-cell transmissibility multipliers of the common face may need to be reconciled. One method to do this is to average the inter-cell transmissibility multiplier values. The average may use uniform weighting or the average may be weighted based on certain properties, for instance, cell pore volume. This optional identifying step 1212 may be conducted in any manner disclosed in this specification. In an alternative embodiment, the simulator that will receive the values from the FSWC model can reconcile the inter-cell transmissibility multipliers of common faces by treating the cells separately, such that this method step is unnecessary.

In an embodiment, each of the steps of the method shown in FIG. 12 is a distinct step. In another embodiment, although depicted as distinct steps in FIG. 12, steps 1202-1212 may not be distinct steps. In other embodiments, the method shown in FIG. 12 may not have all of the above steps and/or may have other steps in addition to or instead of those listed above. The steps of the method shown in FIG. 12 may be performed in another order. Subsets of the steps listed above as part of the method shown in FIG. 12 may be used to form their own method. The steps of method 1200 may be repeated in any combination and order any number of times, for instance, continuously looping in order to cycle through and evaluate the FSWC model for each well-cell 202 in a grid.

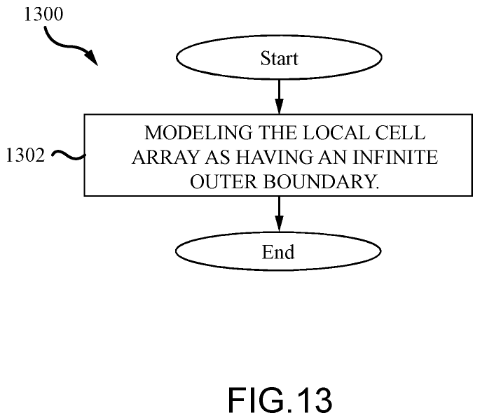

FIG. 13 shows a flowchart of an embodiment of a method 1300 for simplifying a FSWC system. The method 1300 may be reflected in the methods described in FIGS. 11 and 12. The modeling module 102 and/or the response module 104 may be the modeling module 102 and/or the response module 104 taught in any or any combination of the descriptions of FIGS. 1-8 as well as the descriptions of FIGS. 11 and 12, although any suitable modeling module 102 and/or the response module 104 may be employed in alternative embodiments. All methods for accomplishing the steps of the flowcharts disclosed in this specification are contemplated, including all of the capabilities of the computer system 100, the equations presented, the variables presented and described, and the modules of the computer system 100.

Step 1302 is modeling, by the modeling module (102), the local cell array as having an infinite outer boundary. This may be done by the modeling module (102) modeling the grid as an infinite space around the local cell array for determination of parameters for the well-cell (202).

In other embodiments, the method shown in FIG. 13 may have other steps in addition to or instead of the one listed above. The step of method 1300 may be repeated in any combination and order any number of times, for instance, continuously looping in order to cycle through and evaluate the FSWC model for each well-cell 202 in a grid.

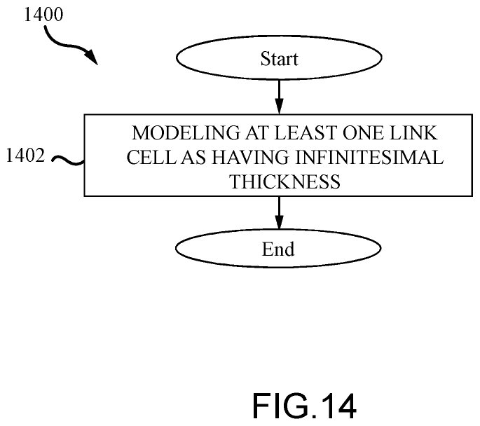

FIG. 14 shows a flowchart of another embodiment of a method 1400 for simplifying a FSWC system. The method 1400 may be reflected in the methods described in FIGS. 11, 12 and 13. The modeling module 102 and/or the response module 104 may be the modeling module 102 and/or the response module 104 taught in any or any combination of the descriptions of FIGS. 1-8 as well as the descriptions of FIGS. 11, 12 and 13, although any suitable modeling module 102 and/or the response module 104 may be employed in alternative embodiments. All methods for accomplishing the steps of the flowcharts disclosed in this specification are contemplated, including all of the capabilities of the computer system 100, the equations presented, the variables presented and described, and the modules of the computer system 100.

Step 1402 is modeling, by the modeling module (102), at least one link-cell (204), as having infinitesimal thickness. This may be done by the modeling module (102) assuming the flow through the common face is the same as the flow out of the link-cell (204) through an external face of the link-cell (204). The modeling module (102) may also assume a pressure difference between inner and outer faces of the common face (Γᵢ) is proportional to a volumetric fluid flowrate between the well-cell (202) and one of the at least one link-cells (204ᵢ) across a thin layer of equivalent transmissibility (T_{0i,i}).

In other embodiments, the method shown in FIG. 14 may have other steps in addition to or instead of the one listed above. The step of method 1400 may be repeated in any combination and order any number of times, for instance, continuously looping in order to cycle through and evaluate the FSWC model for each well-cell 202 in a grid.

### Graphs, Comparisons, and Renderings

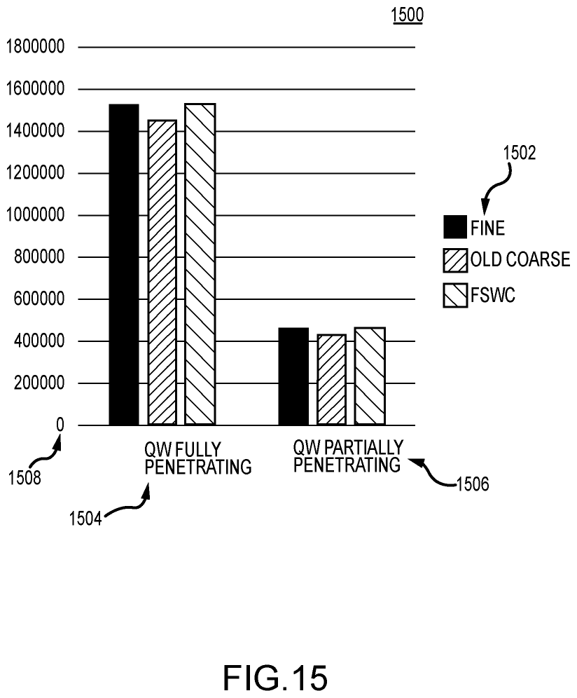

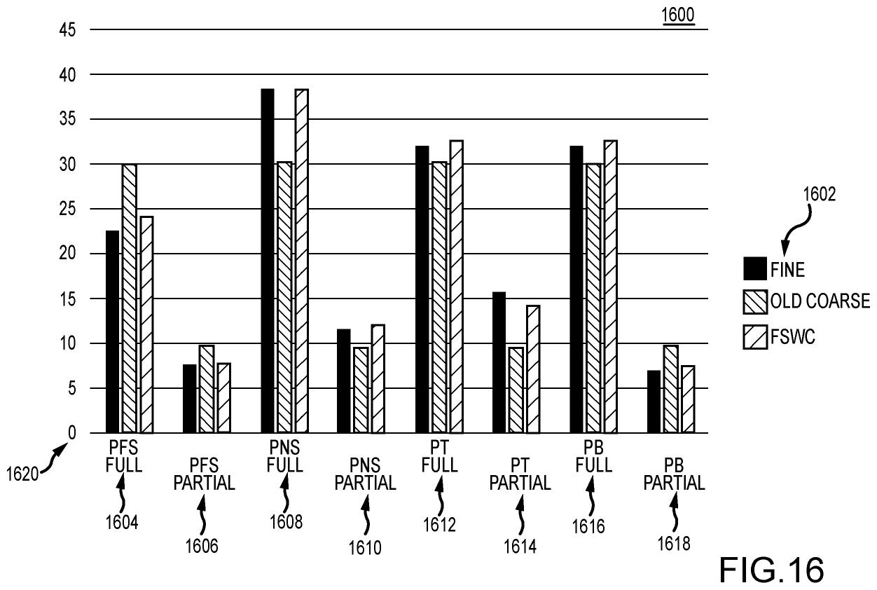

FIGS. 15 and 16 show graphs explaining the anomalies described in the specification. These graphs, comparisons, and renderings demonstrate performance and implementation of the methods and procedures of the disclosed computer system 100.

FIG. 15 shows a graph 1500 of an embodiment of a comparison of flow rates between the FSWC model and existing fine and coarse models. While FSWC is a coarse model, it can be appreciated that the FSWC better approximates the fine model than the old coarse model. The graph has a legend 1502 (showing different shades representing each of the fine, Old Coarse, and FSWC models), a group of abscissa representing the flow rate in a cell with a full perforation 1504, a group of abscissa representing the flow rate in a cell with partial perforation 1506, and an ordinate 1508 representing the flowrates. It can be seen that the FSWC model improves upon the course model by 4.4% in the full perforation example and 7.5% in the partial perforation example when estimating the output of the fine model.

FIG. 16 shows a graph 1600 of an embodiment of a comparison of pressures at different locations of a cell between the FSWC model and existing fine and coarse models. The graph 1600 has a legend (showing different shades representing each of the fine, Old Coarse, and FSWC models) 1602, a group of abscissa representing the pressure at the far side of a cell with a full perforation 1604, a group of abscissa representing the pressure at the far side of a cell with a partial perforation 1606, a group of abscissa representing the pressure at the near side of a cell with a full perforation 1608, a group of abscissa representing the pressure at the near side of a cell with a partial perforation 1610, a group of abscissa representing the pressure at the top of a cell with a full perforation 1612, a group of abscissa representing the pressure at the top of a cell with a partial perforation 1614, a group of abscissa representing the pressure at the bottom of a cell with a full perforation 1616, a group of abscissa representing the pressure at the bottom of a cell with a partial perforation 1618, and an ordinate 1620, representing the quantity of pressure. It can be appreciated that the FSWC model significantly outperforms the old coarse model when calculating pressures at different locations within a cell. This is not surprising, as the old coarse model assumes even pressure throughout the cell, as is shown here.

The detailed descriptions of the above embodiments are not exhaustive descriptions of all embodiments contemplated by the inventors to be within the scope of the present description. Indeed, persons skilled in the art will recognize that certain elements of the above-described embodiments may variously be combined or eliminated to create further embodiments, and such further embodiments fall within the scope and teachings of the present description. It will also be apparent to those of ordinary skill in the art that the above-described embodiments may be combined in whole or in part to create additional embodiments within the scope and teachings of the present description. When specific numbers representing parameter values are specified, the ranges between all of those numbers as well as ranges above and ranges below those numbers are contemplated and disclosed.

Thus, although specific embodiments are described herein for illustrative purposes, various equivalent modifications are possible within the scope of the present description, as those skilled in the relevant art will recognize. The teachings provided herein can be applied to other methods and apparatuses for determining reservoir models, and not just to the embodiments described above and shown in the accompanying figures. Accordingly, the scope of the embodiments described above should be determined from the following claims.

We claim:

1. A free-space well connection method of determining parameters for modeling a reservoir, the method being conducted by a computer system (100) having a processor (110) and non-transitory memory (120) that stores data including instructions to be executed by the processor (110), the processor (110) executing a modeling module (102) stored in the memory (120), the modeling module (102) having data representing a grid with a well-cell (202) and at least one link-cell (204), each of the at least one link-cell (204₁) having a common face (Γᵢ) with the well-cell (202), the well-cell (202) and the at least one link-cell (204) being a local cell array, the method comprising:
modeling, by the modeling module (102), the local cell array as having an infinite outer boundary by modeling the grid as an infinite space around the local cell array for determination of parameters for the well-cell (202); and
determining, by the modeling module (102), one or more of a well connection transmissibility factor (T_{w}) and at least one inter-cell transmissibility multiplier (Mᵢ).

2. A method as claimed in claim 1, further comprising modeling, by the modeling module (102), the at least one link-cell (204), as having infinitesimal thickness, by assuming the flow through the common face is the same as the flow out of the link-cell (204) through an external face of the link-cell (204), and a pressure difference between inner and outer faces of the common face (Γᵢ) is proportional to a volumetric fluid flowrate between the well-cell (202) and one of the at least one link-cells (204ᵢ) across a thin layer of equivalent transmissibility (T_{0i,i}).

3. A method as claimed in claim 1, further comprising:
determining, by the modeling module (102), a minimum distance between a well perforation (Γᵢ) in the well-cell (202) and a point on the common face (Γᵢ); and
splitting, by the modeling module (102), the common face (Γᵢ) into more than one boundary element of a plurality of boundary elements if the minimum distance between a well perforation (Γ_{w}) in the well-cell (202) and a point on the common face (Γᵢ), is less than a predetermined threshold.

4. A method as claimed in claim 3, wherein the point on the common face (Γᵢ) is the point closest to the well perforation (Γ_{w}).

5. A method as claimed in claim 3, wherein the point on the common face (Γᵢ) is the center point of the common face (Γᵢ).

6. A method as claimed in claim 3, wherein if the minimum distance between a well perforation (Γ_{w}) in the well-cell (202) and a point on the common face (Γᵢ), is not less than a predetermined threshold, the common face (Γᵢ) is considered a boundary element of the plurality of boundary elements.

7. A method as claimed in claim 3, further comprising:
determining, by the modeling module (102), a minimum distance between a well perforation (Γ_{w}) in the well-cell (202) and a point on a boundary element of the plurality of boundary elements; and
splitting, by the modeling module (102), the boundary element of the plurality of boundary elements into more than one boundary element of the plurality of boundary elements if the minimum distance (d_{iw}) between a well perforation (Γ_{w}) in the well-cell (202) and a point on the boundary element of the plurality of boundary elements is less than a predetermined threshold.

8. A method as in claim 7, wherein the determination of whether the minimum distance (d_{iw}) is less than a predetermined threshold comprises determining whether one of the ratio of the square of the minimum distance (d_{iw}) to an area of the common face (Γᵢ) and the ratio of the minimum distance (d_{iw}) to a square root of the area of the common face (Γᵢ) is less than a predetermined ratio threshold.

9. A method as in claim 3, wherein the more than one boundary element is four boundary elements.

10. A method as in claim 3, wherein the more than one boundary element is nine boundary elements.

11. A method as in claim 1, further comprising:
determining, by the modeling module (102), a bounding box for one or more of a well perforation (Γ_{w}) and a well perforation segment; and
splitting, by the modeling module (102), the one or more of the well perforation (Γ_{w}) and a well perforation segment into more than one segment if the bounding box size is above a predetermined threshold.

12. A method as claimed in claim 11, wherein the determination of whether the bounding box size is above a predetermined threshold comprises determining whether the maximum dimension (max(b_{w}/b_{c})) of a ratio of well perforation (segment) bounding box (b_{w}) to a well-cell (202) bounding box (b_{c}) exceeds a predetermined ratio threshold.

13-14. (canceled)

15. A method as claimed in claim 1, wherein the cell array is analyzed, by the modeling module (102), by dividing the interface between the well-cell (202) and a link-cell (204ᵢ) of each of the at least one link-cell (204) and an external environment into “layers”, with an “inner layer” representing a relationship of flow between a well perforation (Γ_{w}) and the common face (Γ₀ᵢ≡∂Ω₀ ∩∂Ωᵢ), a “link layer” representing a relationship of flow between the common face (Γ₀ᵢ) and the outer link-cell (204i) face (Γ_{i∞}≡∂Ωᵢ ∩∂Ω_{∞}), and an “outer layer” representing the relationship of flow between the outer link-cell (204i) face (Γ_{i∞}) and the remote boundary (Γ_{∞}) of an infinite domain (Ω_{∞}).

16. A method as claimed in claim 15, wherein the determining, by the modeling module (102), one or more of a well connection transmissibility factor (T_{w}) and at least one inter-cell transmissibility multiplier (Mᵢ) comprises:
evaluating, by the modeling module (102), inner layer equations to form at least one inner boundary condition relation representing physical relationships in the inner layer.

17-25. (canceled)

26. A method as claimed in claim 1, wherein the determining, by the modeling module (102), one or more of a well connection transmissibility factor (T_{w}) and at least one inter-cell transmissibility multiplier (Mᵢ), uses a total number of boundary condition relations, the total number of boundary condition relations being three times the number of boundary elements of the local cell array plus one (3n+1).

27. A method as claimed in claim 1, wherein the determining, by the modeling module (102), one or more of a well connection transmissibility factor (T_{w}) and at least one inter-cell transmissibility multiplier (Mᵢ), comprises assembling all boundary condition relations in a matrix and a right-hand side vector of equation coefficients.

28-33. (canceled)

34. A method as claimed in claim 1, wherein a sum of values of the at least one inter-cell transmissibility multiplier (ΣᵢMᵢ) is equal to a total number of link-cells (204) in a set of active link-cells ( [symbol] ) in the local cell array.

35. A method as claimed in claim 1, further comprising transmitting the one or more of a well connection transmissibility factor (T_{w}) and at least one inter-cell transmissibility multiplier (Mᵢ) to a reservoir simulation that simulates fluid flow in a reservoir and using, by the reservoir simulator, the one or more of a well connection transmissibility factor (T_{w}) and at least one inter-cell transmissibility multiplier (Mᵢ) to simulate fluid flow in a reservoir.

36. (canceled)

37. A method as claimed in claim 1, wherein the determining, by the modeling module (102), one or more of a well connection transmissibility factor (T_{w}) and at least one inter-cell transmissibility multiplier (Mᵢ), accounts for a shape function (ƒ(x, x′)), the shape function representing variations in flux over the common face (Γᵢ).

38. A method as claimed in claim 1 further comprising:
receiving, determining, or inputting, by the modeling module (102), inputs for determining at least one inter-cell transmissibility multiplier and at least one well connection transmissibility factor; and
determining, by the modeling module (102), whether the well-cell (202) is active, based on the inputs.

39. (canceled)

40. A method as in claim 1, further comprising:
if a hydraulic conductivity (K) is a non-diagonal tensor within a predetermined threshold, applying mapping, by the modeling module (102), to spatial coordinates, making the hydraulic conductivity (K) a diagonal tensor.

41. A method as in claim 1, further comprising:
if a hydraulic conductivity (K) is not a scalar within a predetermined threshold, applying mapping, by the modeling module (102), to spatial coordinates, making the hydraulic conductivity (K) a scalar.

42-43. (canceled)

44. A method as in claim 1, wherein identifying of inactive cells is based on a determination, by the modeling module (102), that the cell has one or more of a pore volume that is below a predetermined pore volume threshold, a permeability below a predetermined permeability threshold, and a transmissibility below a predetermined transmissibility threshold.

45. (canceled)

46. A method as claimed in claim 1, wherein the determining, by the modeling module (102), one or more of a well connection transmissibility factor (T_{w}) and at least one inter-cell transmissibility multiplier (Mᵢ), accounts, by the modeling module (102) for a skin factor (S) which is incorporated by the equation, r̅_{w}=r_{w}e^{-S}.

47. A computer system (100) having a processor (110) and non-transitory memory (120) that stores data including instructions to be executed by the processor (110), the processor (110) configured to carry out a free-space well connection method of determining parameters for modeling a reservoir by executing a modeling module (102) stored in the memory (120), the modeling module (102) having data representing a grid with a well-cell (202) and at least one link-cell (204), each of the at least one link-cell (204ᵢ) having a common face (Γᵢ) with the well-cell (202), the well-cell (202) and the at least one link-cell (204) being a local cell array, the modeling module (102) configured to:
model the local cell array as having an infinite outer boundary by modeling the grid as an infinite space around the local cell array for determination of parameters for the well-cell (202); and
determine one or more of a well connection transmissibility factor (T_{w}) and at least one inter-cell transmissibility multiplier (Mᵢ).

48-92. (canceled)
